(19) United States
(12) Patent Application Publication
(10) Pub. No.: US 2024/0238162 A1
(43) Pub. Date: Jul. 18, 2024

(54) SYSTEM, METHOD, AND APPARATUS FACILITATING ASSEMBLY OF A CAPSULE

(71) Applicant: Multiply Labs Inc., San Francisco, CA (US)

(72) Inventor: Federico PARIETTI, San Francisco, CA (US)

(21) Appl. No.: 17/823,065

(22) Filed: Aug. 29, 2022

Related U.S. Application Data
(60) Provisional application No. 63/238,066, filed on Aug. 27, 2021.

(51) Int. Cl. A61J 3/07

(52) U.S. Cl. CPC A61J 3/074

(57) ABSTRACT

The present disclosure is directed to providing systems, methods, and apparatuses for capsule assembly. A capsule assembly apparatus includes a hopper to retain a first plurality of solid dosage forms. The hopper includes an inlet for receiving a member in the first plurality of solid dosage forms, and an outlet for conveying the member towards a dispenser. The dispenser includes through holes to receive at least two members in the first plurality of solid dosage forms. Each through hole includes a first terminal end portion to receive the member, and a second terminal end portion to discharge the member. A gate mechanism is disposed interposing between the outlet and the dispenser and controls the conveying of the member. A tray includes a plurality of openings. Each opening is configured to accommodate both a body and the member, and substantially align directly below a respective through hole.

### CROSS-REFERENCE TO RELATED APPLICATION(S)

The present application claims priority to U.S. Provisional Patent Application No. 63/233,148, entitled “System, Method, and Apparatus Facilitating Assembly of a Capsule,” filed Aug. 13, 2021, which is hereby incorporated by reference in its entirety for all purposes. The present application also claims priority to U.S. Provisional Patent Application No. 63/238,066, entitled “System, Method, and Apparatus Facilitating Assembly of a Capsule,” filed Aug. 27, 2021, which is hereby incorporated by reference in its entirety for all purposes.

### TECHNICAL FIELD

The present disclosure generally relates to systems, methods, and apparatuses for facilitating assembly of a capsule. More particularly, the present disclosure relates to systems, methods, and apparatuses designed to facilitate assembly of a capsule and/or for deposition of one or more solid dosage forms in the capsule.

### BACKGROUND

Traditionally, capsules are produced with labor-intensive processes. These conventional processes have undesirable constraints including a large number of manufacturing operators and employment of highly skilled (and expensive) technicians. These constraints make the manufacture and assembly capsules at an industrial scale particularly difficult.

Given the above background, there is a need in the art for improved systems, methods, and apparatuses for facilitating an improved manufacture of capsules that addresses these dilemmas.

The information disclosed in this background section is only for enhancement of understanding of the general background of the invention and should not be taken as an acknowledgement or any form of suggestion that this information forms the prior art already known to a person skilled in the art.

### SUMMARY

Advantageously, the systems, methods, and apparatuses detailed in the present disclosure address the shortcomings in the prior art detailed above.

Systems, methods, and apparatuses for broadly implementing assembly of a plurality of capsules are provided.

Specifically, exemplary systems, methods, and apparatuses of the present disclosure provide for forming a plurality of capsules and/or assembling the plurality of capsules. In some embodiments, each capsule in the plurality of capsules is a multi-compartment capsule.

In some embodiments, the invention is directed to providing a capsule assembly apparatus. The capsule assembly apparatus includes a hopper. The hopper is configured to retain a first plurality of a solid dosage form. The hopper includes an inlet for receiving a member in the first plurality of solid dosage forms. Moreover, the hopper includes an outlet for conveying the member in the first plurality of solid dosage forms towards a dispenser. The dispenser includes a plurality of through holes that is configured to receive at least two members in the first plurality of solid dosage forms. Furthermore, each through hole in the plurality of through holes includes a first terminal end portion configured to receive the member in the first plurality of solid dosage forms at a first end portion of the dispenser. Additionally, each through hole in the plurality of through holes includes a second terminal end portion configured to discharge the member in the first plurality of solid dosage forms at a second end portion opposite the first end portion of the dispenser. The capsule assembly apparatus includes a first gate mechanism disposed interposing between the outlet of the hopper and the dispenser. The first gate mechanism is configured to control the conveying of the member in the first plurality of solid dosage forms. Moreover, a first actuation mechanism is configured to control a movement of the hopper in a first direction. The capsule assembly apparatus further includes a tray. The tray includes a plurality of openings. Each opening in the plurality of openings is configured to accommodate both a body and the member in the first plurality of solid dosage forms. Additionally, each opening in the plurality of openings is configured to substantially align directly below the second terminal end portion of a respective through hole in the plurality of through holes.

In some embodiments, the capsule assembly apparatus further includes a transport mechanism disposed at a lower end portion of the hopper. The transport mechanism is configured to covey the member in the first plurality of solid dosage forms from a portion of the hopper towards at least the outlet of hopper.

In some embodiments, the outlet is disposed at a position at or above of the maximum height of the respective through hole in the plurality of through holes of the dispenser.

In some embodiments, the capsule assembly apparatus further includes a second gate mechanism disposed adjacent to the outlet of the hopper. The second gate mechanism is configured to control access by the member in the first plurality of solid dosage forms through the outlet of the hopper.

In some embodiments, the first gate mechanism includes one or more channels configured to control the conveying the member in the first plurality of solid dosage forms through the capsule assembly apparatus.

In some embodiments, the first gate mechanism includes a first cam mechanism configured to control the conveyance of the member in the first plurality of solid dosage forms received by the channel in the one or more channels of the first gate mechanism. The first gate mechanism further includes a second cam mechanism configured to control the conveying of the member in the first plurality of solid dosage forms discharged by the channel in the one or more channels of the first gate mechanism.

In some embodiments, the first cam mechanism and the second cam mechanism collectively utilize a second actuation mechanism.

In some embodiments, the capsule assembly apparatus further includes a third gate mechanism disposed interposing between the dispenser and the tray. The third gate mechanism is configured to control the discharge of the member in the first plurality of solid dosage forms from the dispenser.

In some embodiments, the third gate mechanism includes a metering plate.

In some embodiments, the dispenser is a three-dimensional monolithic body.

In some embodiments, the dispenser further includes a surface extending from an upper end portion of the dispenser towards the outlet of the hopper.

In some embodiments, the surface includes a plurality of grooves. Each groove in the plurality of grooves includes a third terminal end portion adjacent to a corresponding first terminal end portion of a respective through hole.

In some embodiments, each opening in the plurality of openings of the tray is individually spaced at a predetermined interval along a dimension of the tray.

In some embodiments, further includes a third actuation mechanism configured to control a movement of the tray or the dispenser in a linear direction.

In some embodiments, the hopper, the dispenser, the tray, or a combination thereof includes a transparent or translucent material.

In some embodiments, each solid dosage form in the first plurality of solid dosage forms includes a first size between 2 millimeter (mm) and 35 mm.

In some embodiments, each solid dosage form in the first plurality of solid dosage forms includes a rotationally symmetrical body that includes a side wall and a base.

In some embodiments, a surface of the tray includes a two- or three-dimensional indicium.

In some embodiments, each opening in the plurality of openings includes a second size at a first end portion of the tray and a third size at a second end portion of the tray. A first size of each solid dosage form in the first plurality of solid dosage forms is equal to or less than the second size of each opening and greater than the third size of each opening.

In some embodiments, the invention is directed to providing a capsule assembly system. In some embodiments, the capsule assembly system includes one or more capsule assembly apparatuses.

In some embodiments, the invention is directed to providing a method for assembling a capsule. The method includes holding a first capsule body. The method further includes filling a first internal volume of a cavity of the first capsule body with a first material. Additionally, the method includes disposing a first divider body in the cavity of the first capsule body. Furthermore, the method includes filling a second internal volume of the cavity of the first capsule body with a second material. The method includes disposing a second divider in the cavity of the capsule first body. Moreover, the method includes filling a third internal volume of the cavity of the first capsule body with a third material. The method includes coupling a second capsule body with the first capsule body, thereby assembling the capsule including a plurality of internal compartments.

The systems, methods, and apparatuses of the present disclosure have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates an exemplary modular capsule assembly system topology including a computer system, in accordance with an embodiment of the present disclosure:

FIG. 2 illustrates various modules and/or components of a computer system for facilitating assembly of a capsule, in accordance with an exemplary embodiment of the present disclosure:

FIG. 3 illustrates a capsule assembly apparatus, in accordance with an embodiment of the present disclosure:

FIG. 4 illustrates another capsule assembly apparatus including a plurality of sensors, in accordance with an embodiment of the present disclosure:

FIG. 5 illustrates yet another capsule assembly apparatus, in accordance with an embodiment of the present disclosure:

FIGS. 6, 7A, and 7B collectively illustrate a first gate mechanism and a second gate mechanism of a capsule assembly apparatus, in accordance with an exemplary embodiment of the present disclosure:

FIG. 8A illustrates a gate mechanism of a capsule assembly apparatus, in accordance with an exemplary embodiment of the present disclosure:

FIG. 8B illustrates another gate mechanism of a capsule assembly apparatus, in accordance with an exemplary embodiment of the present disclosure:

FIG. 8C illustrate a cross-sectional view along line C-C of FIG. 8A, in accordance with an exemplary embodiment of the present disclosure:

FIG. 8D illustrates a portion of a capsule assembly apparatus including a hopper, in accordance with an exemplary embodiment of the present disclosure:

FIG. 8E illustrates a bin of a hopper of a capsule assembly apparatus, in accordance with an exemplary embodiment of the present disclosure:

FIG. 8F illustrates a first gate mechanism and a second gate mechanism of a hopper of a capsule assembly apparatus, in accordance with an exemplary embodiment of the present disclosure:

FIG. 8G illustrates a surface of a dispenser of a capsule assembly apparatus, in accordance with an exemplary embodiment of the present disclosure:

FIG. 8H illustrates a gate mechanism including a first cam mechanism and a second cam mechanism of a capsule assembly apparatus, in accordance with an exemplary embodiment of the present disclosure.

FIG. 9A, illustrates a tray, in accordance with an exemplary embodiment of the present disclosure:

FIG. 9B, illustrates another tray, in accordance with an exemplary embodiment of the present disclosure:

FIG. 9C, illustrates yet another tray, in accordance with an exemplary embodiment of the present disclosure:

FIG. 10A illustrate a cross-sectional view along line A-A of FIG. 9A, in accordance with an exemplary embodiment of the present disclosure:

FIG. 10B illustrate a cross-sectional view along line B-B of FIG. 9B, in accordance with an exemplary embodiment of the present disclosure:

FIG. 10C illustrate a cross-sectional view along line C-C of FIG. 9C, in accordance with an exemplary embodiment of the present disclosure:

FIGS. 11A, 11B, and 11C collectively illustrate a plurality of trays coupling with a docking station, in accordance with an exemplary embodiment of the present disclosure:

FIG. 12 illustrates a plurality of trays and a capsule assembly apparatus, in accordance with an exemplary embodiment of the present disclosure;

FIG. 13A illustrates an alignment of a plurality of trays and a docking station, in accordance with an exemplary embodiment of the present disclosure:

FIG. 13B illustrates a coupling of a plurality of trays and a docking station, in accordance with an exemplary embodiment of the present disclosure:

FIG. 14A illustrates a cross-sectional view of a plurality of trays with a gate mechanism, in accordance with an exemplary embodiment of the present disclosure:

FIG. 14B illustrates a cross-sectional view of a plurality of trays with a gate mechanism and a divider, in accordance with an exemplary embodiment of the present disclosure:

FIGS. 15A and 15B collectively illustrate a cross-sectional view of a plurality of trays with a gate mechanism and a divider in a first position and a second position, respectively, in accordance with an exemplary embodiment of the present disclosure:

FIGS. 16A, 16B, and 16C collectively illustrate a plurality of stages of assembling a capsule at a capsule assembly apparatus, in accordance with an exemplary embodiment of the present disclosure:

FIGS. 17A and 17B collectively illustrate various stages of assembling a capsule at a capsule assembly apparatus, in accordance with an exemplary embodiment of the present disclosure:

FIG. 18A illustrates a capsule assembly apparatus and a plurality of tray apparatuses, in accordance with an exemplary embodiment of the present disclosure:

FIG. 18B illustrates another capsule assembly apparatus and a plurality of tray apparatuses, in accordance with an exemplary embodiment of the present disclosure:

FIG. 18C illustrates yet another capsule assembly apparatus, in accordance with an exemplary embodiment of the present disclosure:

FIG. 19A illustrates a tray apparatus with a first tray including a plurality of capsule bodies, in accordance with an exemplary embodiment of the present disclosure:

FIG. 19B illustrates a tray and a shelf device, in accordance with an exemplary embodiment of the present disclosure:

FIG. 20 illustrates a portion of a tray apparatus, in accordance with an exemplary embodiment of the present disclosure:

FIG. 21 illustrates a tray apparatus and a docking station, in accordance with an exemplary embodiment of the present disclosure: and

FIG. 22 illustrates a method for assembling a capsule, in accordance with an exemplary embodiment of the present disclosure.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The present disclosure provides systems, methods, and apparatuses for facilitating automated assembly of a plurality of capsules. Exemplary systems, methods, and apparatuses for the assembly of the plurality of capsules of the present disclosure includes the advantages of modularity, flexibility, and scalability. Moreover, exemplary systems, methods, and apparatuses of the present disclosure retain the benefits of a conventional closed-system processes, such as by providing a sterile clean room environment, without sacrificing the aforementioned advantages. Furthermore, exemplary systems, methods, and apparatus of the present disclosure leverage advanced robotic features and technologies that enable the transformation of capsule assembly from labor-based and low-throughput process to a fully industrialized, high-throughput process with high scale, efficiency, and repeatability.

The present disclosure is directed to providing systems, methods, and apparatuses for capsule assembly. In some embodiments, a capsule assembly apparatus of the present disclosure is provided in order to facilitating deposition of a plurality of solid dosage forms (e.g., a plurality of solid dosage forms), into a plurality of bodies (e.g., a plurality of capsule bodies). The capsule assembly apparatus includes a hopper, which is utilized to retain a first plurality of solid dosage forms. In some embodiments, the hopper includes a plurality of side walls, which prevents the first plurality of solid dosage forms from becoming contaminated or accidentally removed from the hopper. Furthermore, the hopper includes an inlet for receiving a member (e.g., a first dosage form) in the first plurality of solid dosage forms. Moreover, the hopper includes an outlet for conveying the member towards a dispenser. The dispenser includes a plurality of through holes that configured is to receive at least two members in the first plurality of solid dosage forms. Each through hole includes a first terminal end portion configured to receive the member, and a second terminal end portion configured to discharge the member, which allows each through hole to at least transport the member. Additionally, in some embodiments, the capsule assembly apparatus includes a gate mechanism that at least controls the conveying of the member. In some embodiments, the gate mechanism is disposed interposing between the outlet and the dispenser. In some embodiments, the capsule assembly apparatus further includes a tray. The tray includes a plurality of openings, each of which is configured to accommodate both a body (e.g., a first capsule body in the plurality of capsule bodies) and the member. The tray is further configured to substantially align directly below a respective through hole, which allows for directly receiving the member from the respective through hole to an opening in the plurality of openings. Accordingly, the capsule apparatus of the present disclosure provides a gated capsule assembly apparatus, in which the gate mechanism prevents spillage of the dosage forms. Furthermore, in some embodiments, the capsule assembly apparatus is configured to assembly a capsule (e.g., dispose the member within the body of the capsule) with minimal shear forces applied to the body and/or the member, which reduces damage to shear sensitive particulates of the member.

Reference will now be made in detail to various embodiments of the present disclosure, examples of which are illustrated in the accompanying drawing and described below: While the disclosure will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents, and other embodiments, which may be included within the spirit and scope of the present invention as defined by the appended claims.

It will also be understood that, although the terms first, second, etc. may be used herein to describe various elements, these elements should not be limited by these terms. These terms are only used to distinguish one element from another. For example, a first capsule could be termed a second capsule, and, similarly, a second capsule could be termed a first capsule, without departing from the scope of the present disclosure. The first capsule and the second capsule are both capsules, but they are not the same capsule.

The terminology used in the present disclosure is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and or “comprising,” when used in this specification, specify the presence of stated features, integers, steps, operations, elements, and or components, but do not preclude the presence or addition of one or more other features, integers, steps, operations, elements, components, and/or groups thereof.

As used herein, the term “if” may be construed to mean “when” or “upon” or “in response to determining” or “in response to detecting.” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

As used herein, the term “about” or “approximately” can mean within an acceptable error range for the particular value as determined by one of ordinary skill in the art, which can depend in part on how the value is measured or determined, e.g., the limitations of the measurement system. For example, “about” can mean within 1 or more than 1 standard deviation, per the practice in the art. “About” can mean a range of +20%, +10%, +5%, or +1% of a given value. Where particular values are described in the application and claims, unless otherwise stated, the term “about” means within an acceptable error range for the particular value. The term “about” can have the meaning as commonly understood by one of ordinary skill in the art. The term “about” can refer to #10%. The term “about” can refer to +5%.

Furthermore, when a reference number is given an “i^{th}” denotation, the reference number refers to a generic component, set, or embodiment. For instance, a capsule termed “capsule i” refers to the i^{th} capsule in a plurality of capsules.

The foregoing description included example systems, methods, techniques, instruction sequences, and computing machine program products that embody illustrative implementations. For purposes of explanation, numerous specific details are set forth in order to provide an understanding of various implementations of the inventive subject matter. It will be evident, however, to those skilled in the art that implementations of the inventive subject matter may be practiced without these specific details. In general, well-known instruction instances, protocols, structures, and techniques have not been shown in detail.

The foregoing description, for purpose of explanation, has been described with reference to specific implementations. However, the illustrative discussions below are not intended to be exhaustive or to limit the implementations to the precise forms disclosed. Many modifications and variations are possible in view of the above teachings. The implementations are chosen and described in order to best explain the principles and their practical applications, to thereby enable others skilled in the art to best utilize the implementations and various implementations with various modifications as are suited to the particular use contemplated.

In the interest of clarity, not all of the routine features of the implementations described herein are shown and described. It will be appreciated that, in the development of any such actual implementation, numerous implementation-specific decisions are made in order to achieve the designer's specific goals, such as compliance with use case- and business-related constraints, and that these specific goals will vary from one implementation to another and from one designer to another. Moreover, it will be appreciated that such a design effort might be complex and time-consuming, but nevertheless be a routine undertaking of engineering for those of ordering skill in the art having the benefit of the present disclosure.

An aspect of the present disclosure is directed to providing systems, methods, and apparatuses for facilitating automated modular manufacture of a plurality of capsules, such as by assembling the plurality of capsules. In some embodiments, the systems, methods, and apparatus of the present disclosure facilitate the assembly of the plurality of capsules without interference from human (e.g., without human intervention).

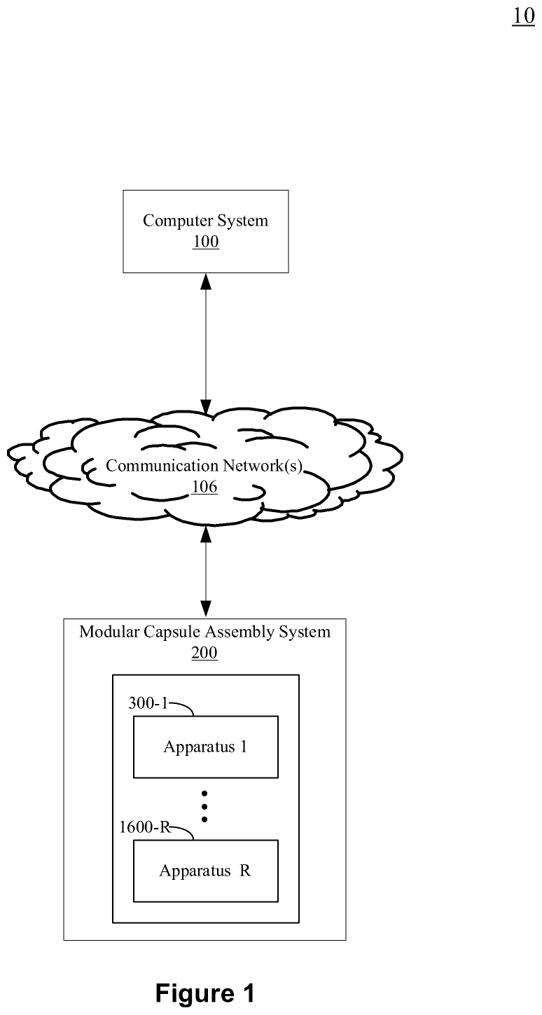

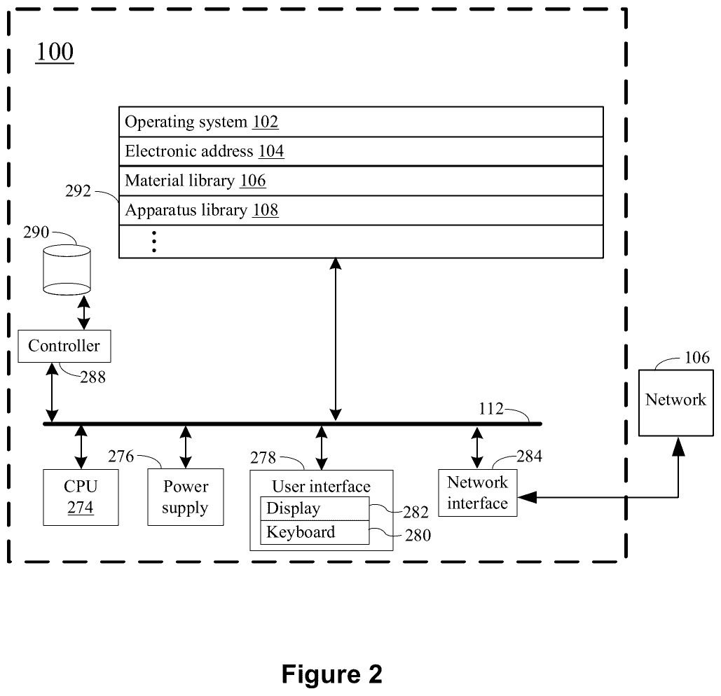

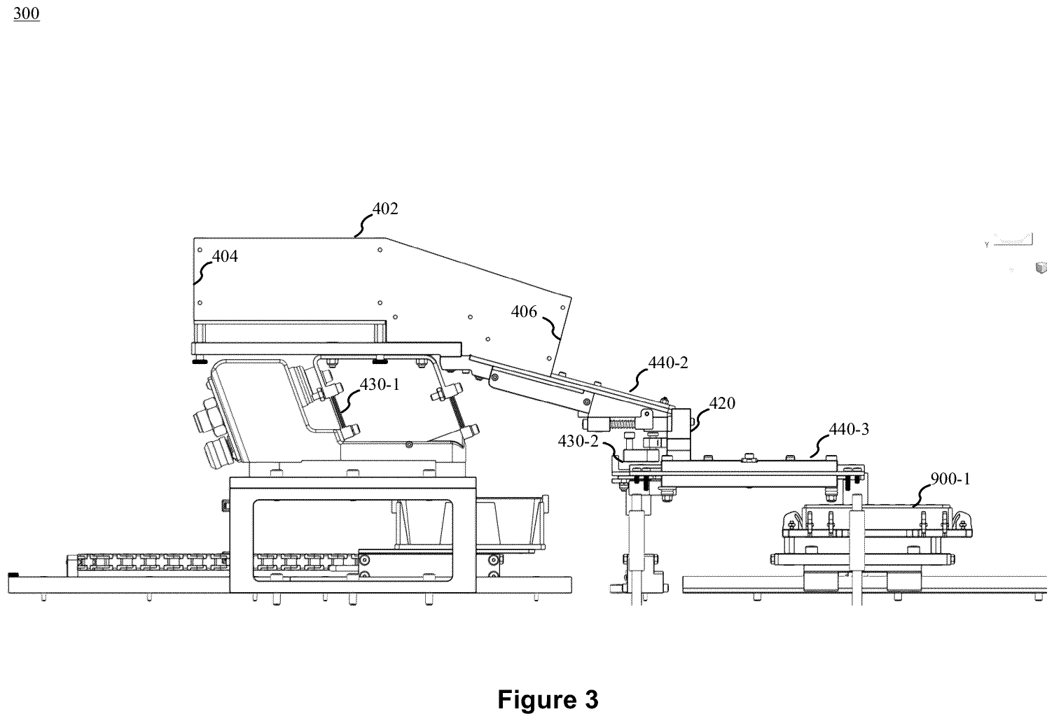

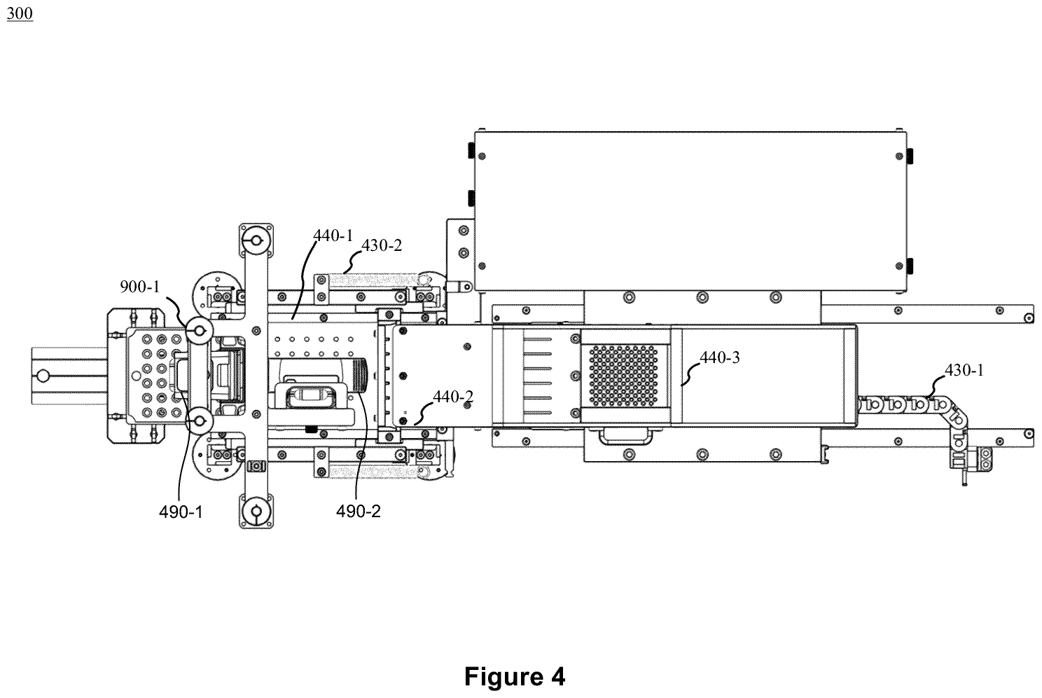

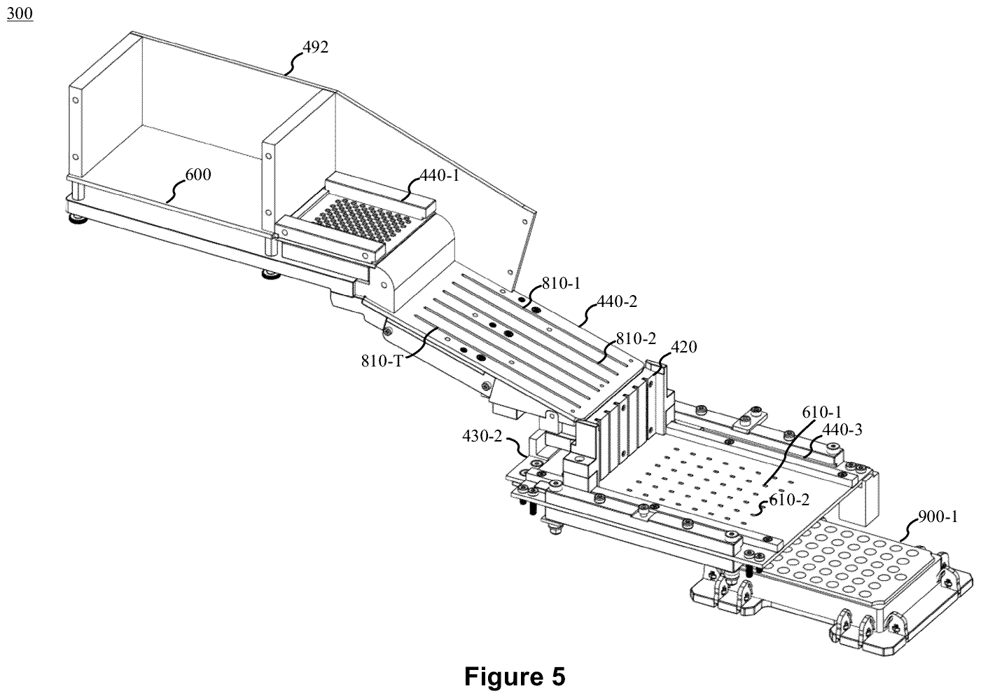

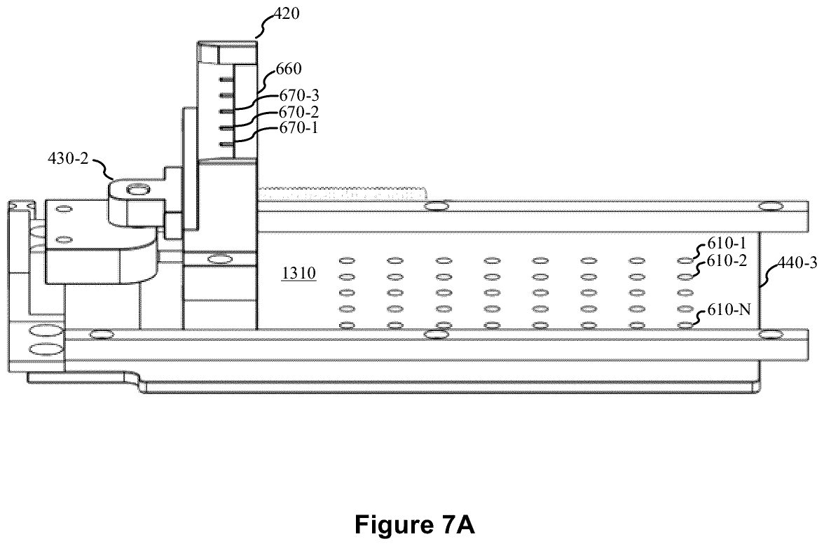

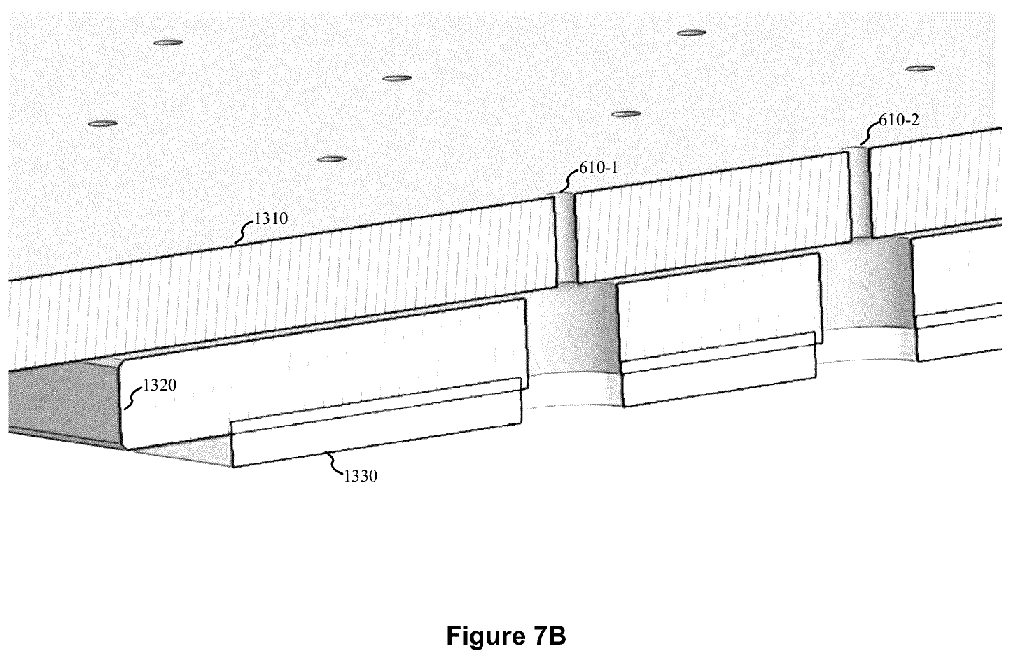

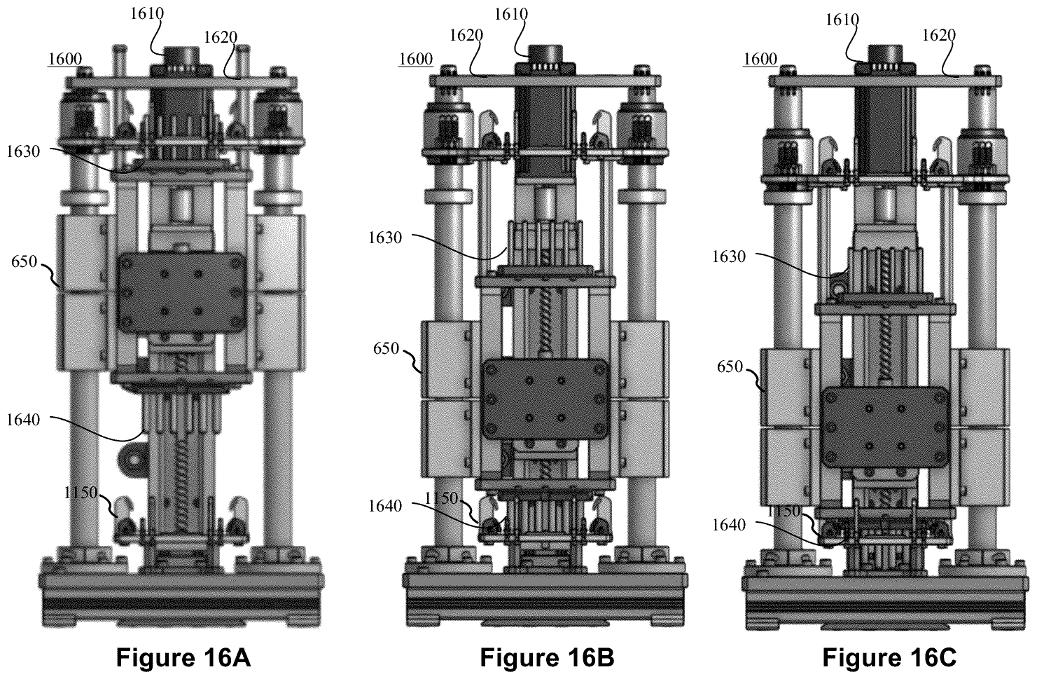

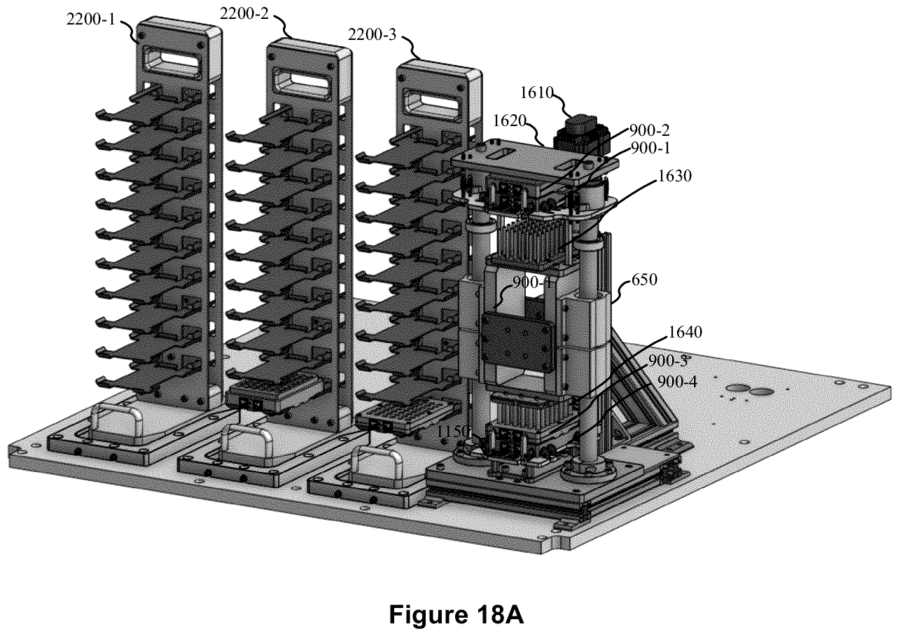

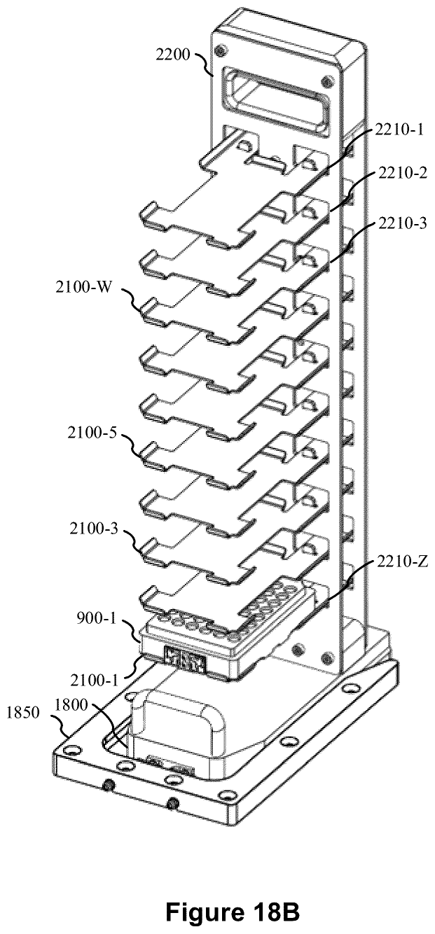

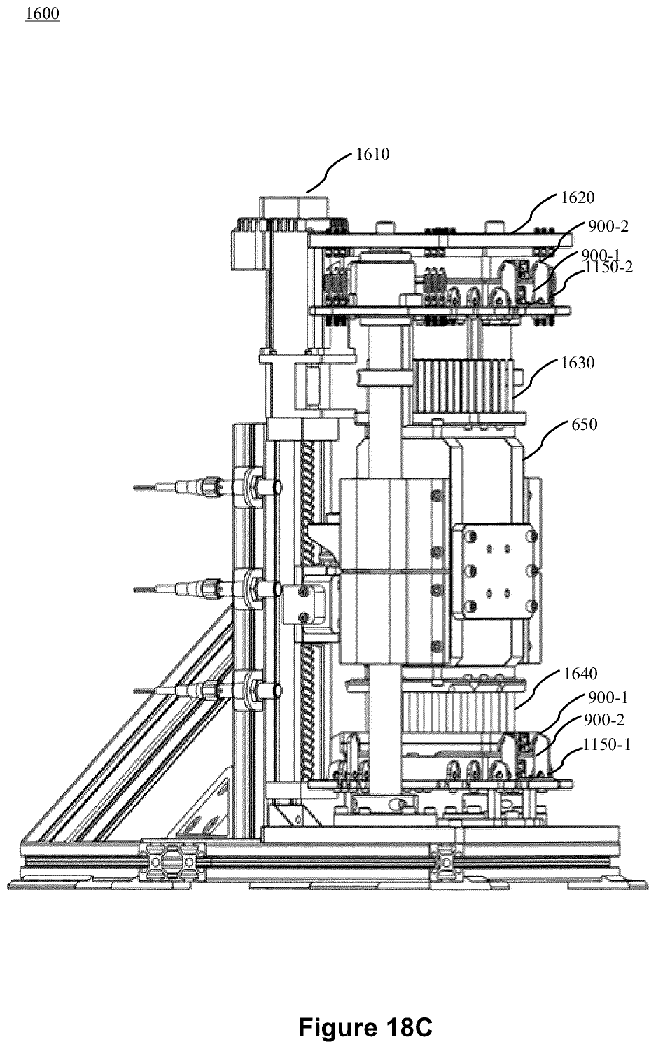

A detailed description of an exemplary system 10 for implementing the automated modular production of the plurality of capsules is described in conjunction with FIG. 1 through FIG. 22. More particularly, FIG. 1 and FIG. 2 collectively illustrate an exemplary topology of the system 10. In the topology, there is a computer system 100 for generating a workflow that produces a plurality of capsules, such as one or more instructions for controlling an actuation mechanism (e.g., first actuation mechanism 430-1 of FIG. 3, second actuation mechanism 430-2 of FIG. 3, first actuation mechanism 430-1 of FIG. 5, second actuation mechanism 430-2 of FIG. 5, second actuation mechanism 430-2 of FIG. 5, second actuation mechanism 430-2 of FIG. 7, etc.) of a capsule assembly apparatus (e.g., capsule assembly apparatus 300 of FIG. 3, capsule assembly apparatus 300 of FIG. 4, capsule assembly apparatus 300 of FIG. 5, capsule assembly apparatus 1600 of FIG. 16A, capsule assembly apparatus 1600 of FIG. 16B, capsule assembly apparatus 1600 of FIG. 16C, capsule assembly apparatus 1600 of FIG. 18A, etc.). In some embodiments, the system 10 includes a modular capsule assembly system 200 that provides an environment for assembling the plurality of capsules. In some embodiments, the module capsule assembly system 200 is in communication with (e.g., by communication network 106) one or more apparatuses 300 that facilitate the assembly of the plurality of capsules at the modular capsule assembly system. However, the present disclosure is not limited thereto.

In some embodiments, the computer system 100 and the modular capsule assembly system 200 are in a single monolithic casing without a communication network 106. In other embodiments, the computer system 100 and the modular capsule assembly system 200 are separated by some distance and are in electrical communication with each other over the communication network as illustrated in FIG. 1.

In some embodiments, the communication network 106 optionally includes the Internet, one or more local area networks (LANs), one or more wide area networks (WANs), other types of networks, or a combination of such networks.

Examples of communication networks 106 include the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

In various embodiments, the computer system 100 includes one or more processing units (CPUs) 274, a network or other communications interface 284, and memory 292.

The memory 292 includes high-speed random access memory, such as DRAM, SRAM, DDR RAM, or other random access solid state memory devices, and optionally also includes non-volatile memory, such as one or more magnetic disk storage devices, optical disk storage devices, flash memory devices, or other non-volatile solid state storage devices. Memory 292 may optionally include one or more storage devices remotely located from the CPU(s) 274. Memory 292, or alternatively the non-volatile memory device(s) within memory 292, includes a non-transitory computer readable storage medium. Access to memory 292 by other components of the computer system 100, such as the CPU(s) 274, is, optionally, controlled by a controller. In some embodiments, memory 292 can include mass storage that is remotely located with respect to the CPU(s) 274. In other words, some data stored in memory 292 may in fact be hosted on devices that are external to the computer system 100, but that can be electronically accessed by the computer system 100 over an Internet, intranet, or other form of network 106 or electronic cable using communication interface 284.

In some embodiments, the memory 292 of the computer system 100 for assembling a capsule stores:
an operating system 102 (e.g., ANDROID, IOS, DARWIN, RTXC, LINUX, UNIX, OS X, WINDOWS, or an embedded operating system such as VxWorks) that includes procedures for handling various basic system services;
an electronic address 104 associated with the computer system 100 that identifies the computer system 100;
a material library 106 that stores one or more data sets, each data set in the one or more data set associated with a corresponding material utilized by the system 10 including a material of a r capsule body and/or a solid dosage form accommodated by the capsule body, such as a size of a solid dosage form accommodated by the capsule body, a first density of the solid dosage form, a second density of the capsule body, and the like; and
an apparatus library 108 that stores information associated with one or more apparatuses of the system 10, such as a location of a first capsule assembly apparatus, a state of a second capsule assembly apparatus, (e.g., a power state of the respective apparatus, a filling state of the respective apparatus, etc.), and the like.

In some embodiments, as indicated above, the electronic address is associated with computer system. The electronic address is utilized to at least uniquely identify the computer system from other devices and components of the distributed system, such as other devices having access to the communications network. For instance, in some embodiments, the electronic address is utilized to receive a request from a remote device to manufacture a capsule using a capsule assembly apparatus of the present disclosure. However, the present disclosure is not limited thereto.

In some embodiments, the material library stores a record of solid dosage forms. In some embodiments, the record of a solid dosage form includes information about one or more indications of the solid dosage form, one or more dosages of the solid dosage form (e.g., amlodipine is available for inclusion in a capsule as a 2.5 mg tablet solid dosage form, a 5 mg tablet solid dosage form, a 10 mg tablet solid dosage form, or a combination thereof) and the like. Accordingly, in some embodiments, each solid dosage form is a consumable good.

Furthermore, in some embodiments, the record of the solid dosage form includes information about one or more dimensional constraints of the solid dosage form. In some embodiments, each dimensional constraint describes an ability to partition (e.g., sub-divide) the solid dosage form into one or more dosages (e.g., a particular mass, a particular volume, etc.). In some embodiments, the one or more dimensional constraints for the solid dosage form includes a volume of the solid dosage form, a minimum size of the solid dosage form, a mass of a minimum effective dosage of the solid dosage form and/or a maximum effective dosage of the solid dosage form, or a combination thereof. However, one of skill in the art will appreciate that the present disclosure is not limited thereto.

In some embodiments, the computer system includes a workflow module that facilitates storing and generating one or more workflows. Each workflow defines parameters for executing assembly of a capsule at a capsule assembly apparatus. In this way, in some embodiments, the computer system 100 repeats the first workflow, for instance, in accordance with a determination that assembly of a plurality of capsules did not satisfy the end-user or one or more computational models. Furthermore, in some embodiments, the computer system 100 communicates a retained workflow to a capsule assembly apparatus or a server, allowing the retained workflow to be reiterated and/or performed outside of the computer system 100 computing environment. However, the present disclosure is not limited thereto.

In some embodiments, the workflow module facilitates evaluates a request to assemble of a plurality of capsules, and generates a corresponding workflow based on the request. In some embodiments, the workflow module receives data relating to a first workflow and generates a second workflow based on the first workflow. In this way, in some embodiments, the workflow module produces novel workflows for assembling the plurality of capsules at the capsule assembly apparatus based on previous instances of the assembly. In some embodiments, the workflow module includes one or more evaluation models, which provide a unique evaluation of a process of assembly of the plurality of capsules, such as whether a threshold number of solid dosage forms is accommodated by a body 1900. From this, in some embodiments, the workflow module utilizes an evaluation model for verification of a workflow being performed at a capsule assembly apparatus. However, the present disclosure is not limited thereto.

In some embodiments, the workflow module includes one or more computational utilized to determine n-dimensional vectors (e.g., feature vectors) whose numerical components describe select observable characteristics associated with the assembly of the plurality of capsules, such as an orientation of a member in a first plurality of solid dosage forms or the ROI. In some embodiments, the one or more computational models is utilized to determine if a threshold condition associated with a quality of the member is satisfied, such as whether the member includes a material defect. In some embodiments, the one or more computational models of the workflow module accomplish this by using a decision tree evaluation model, a neural network evaluation model, a support vector machine (SVM) evaluation model, a Naïve Bayes evaluation model, a pattern-matching evaluation model, a Bayesian evaluation model, a rule-based evaluation model, or a combination thereof. However, the present disclosure is not limited thereto. Furthermore, in some embodiments, the decision tree evaluation model, the neural network evaluation model, the SVM evaluation model, the Naïve Bayes evaluation model, the pattern-matching evaluation model, the Bayesian evaluation model, the rule-based evaluation model, or the combination thereof is utilized in determining a characteristic (e.g., an identify, a material property) of the member.

Additionally, in some embodiments, the workflow module facilities determining if a corresponding value for one or more threshold condition when assembling the plurality of capsules is satisfied based upon a plurality of measurements associated with a capsule assembly apparatus, such as one or more measurements acquired from one or more two-dimensional pixelated sensors (e.g., first two-dimensional pixelated sensor 490-1 of FIG. 4, second two-dimensional pixelated sensor 490-2 of FIG. 4, etc.). By way of example, in some embodiments, in accordance with a determination that a quantity of solid dosage forms accommodated by a body 1900 of a tray 900 does not satisfy a first threshold condition, the workflow module produces a workflow for assembling the plurality of capsules that ensures the satisfaction of the first threshold condition. In this way, if the assembly of the plurality of capsules does not adequately satisfy one or more threshold conditions, a second workflow is generated by the workflow module to ensure adequately satisfy the one or more threshold conditions. However, the present disclosure is not limited thereto. In some embodiments, the threshold condition includes a shape of the member in the first plurality of solid dosage forms, a size of the member in the first plurality of solid dosage forms, a homogeneity of the first plurality of solid dosage forms, a flow property of the first plurality of solid dosage forms, a moisture level of a portion of the capsule assembly apparatus, an agglomeration of the first plurality of solid dosage forms, or a combination thereof.

Additional details and information regarding forming a workflow at a modular capsule assembly system is be found at International Patent Application no.: PCT/US2021/018927, entitled “Systems and Methods for Facilitating Modular and Parallelized Manufacturing at a Biological Foundry,” filed Feb. 19, 2021, which is hereby incorporated by reference in its entirety for all purposes.

Referring to FIG. 3 through FIG. 7, a capsule assembly apparatus is provided.

Specifically, referring to FIG. 3 through FIG. 11C, in some embodiments, a capsule assembly apparatus (e.g., capsule assembly apparatus 300 of FIG. 3, capsule assembly apparatus 300 of FIG. 4, capsule assembly apparatus 300 of FIG. 5, etc.) is provided for facilitating assembly of a capsule that includes one or more solid dosage forms in a first plurality of solid dosage forms.

In some embodiments, a solid dosage form is a tablet or a pill. In some embodiments, the solid dosage form includes at least one solid active ingredient. In some embodiments, the solid dosage form includes one or more solid excipients, such as one or more binders. In some embodiments, the solid dosage form is coated with a layer of material, resulting in at least one core layer and at least one coating layer of the solid dosage form. However, the present disclosure is not limited thereto.

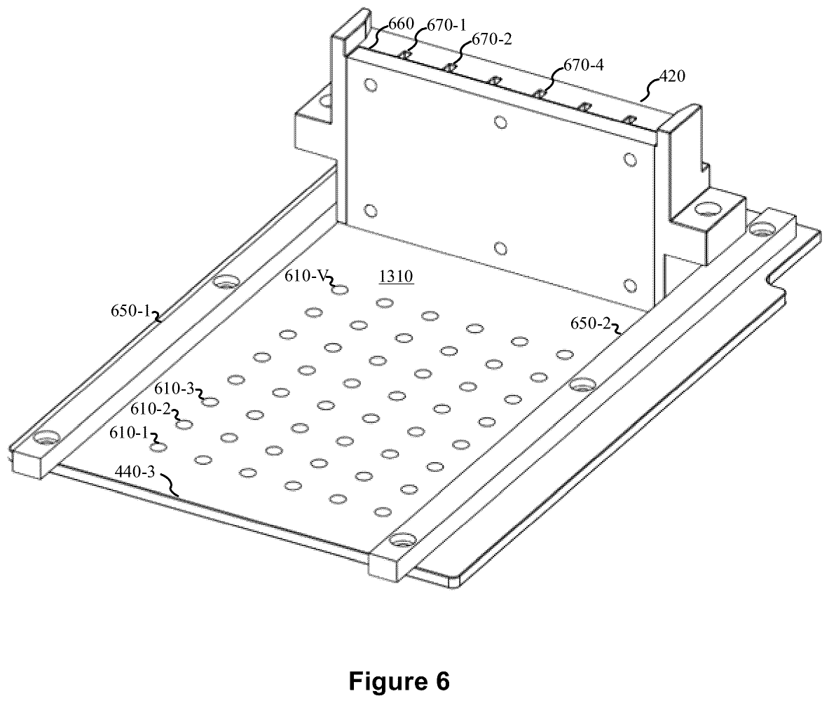

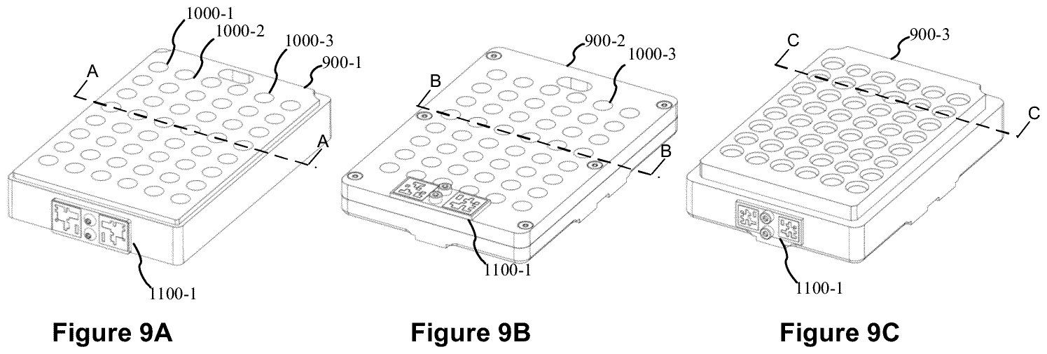

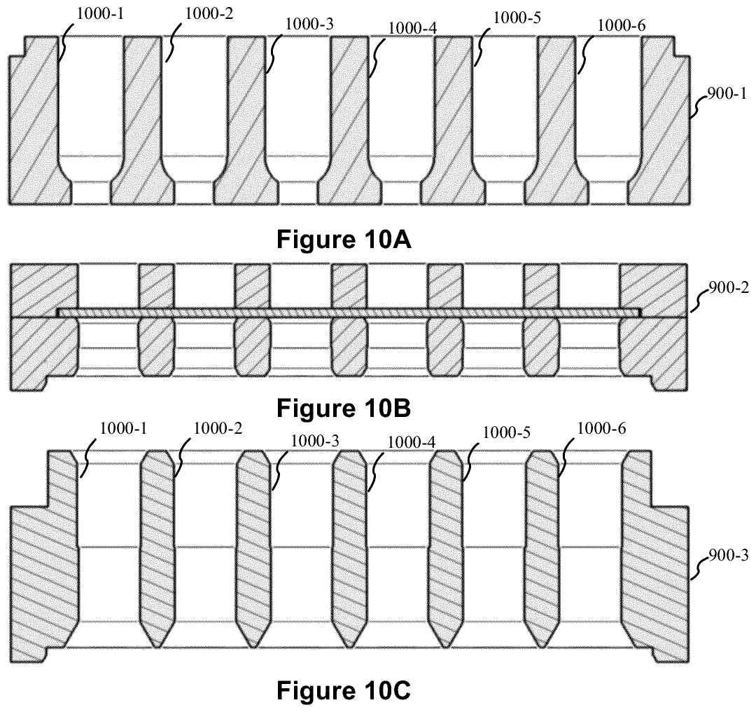

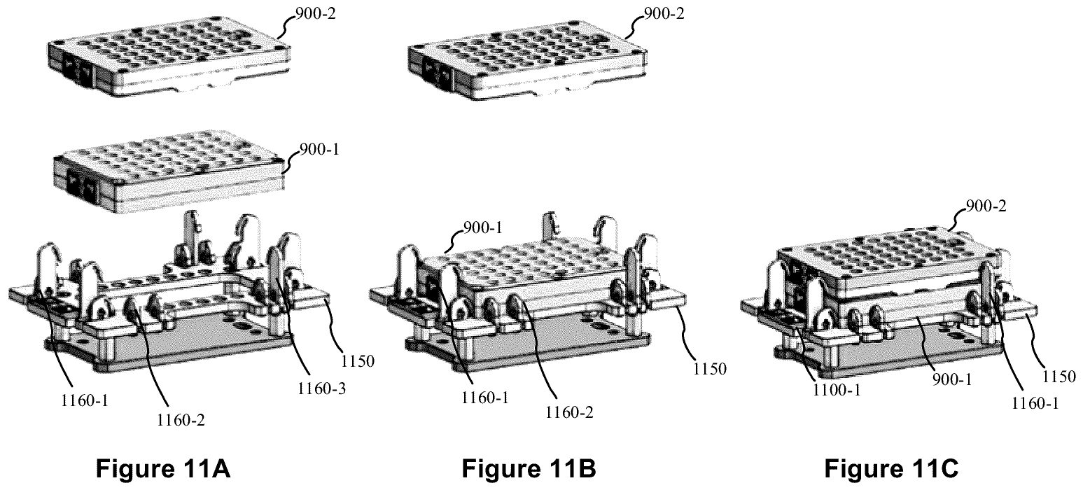

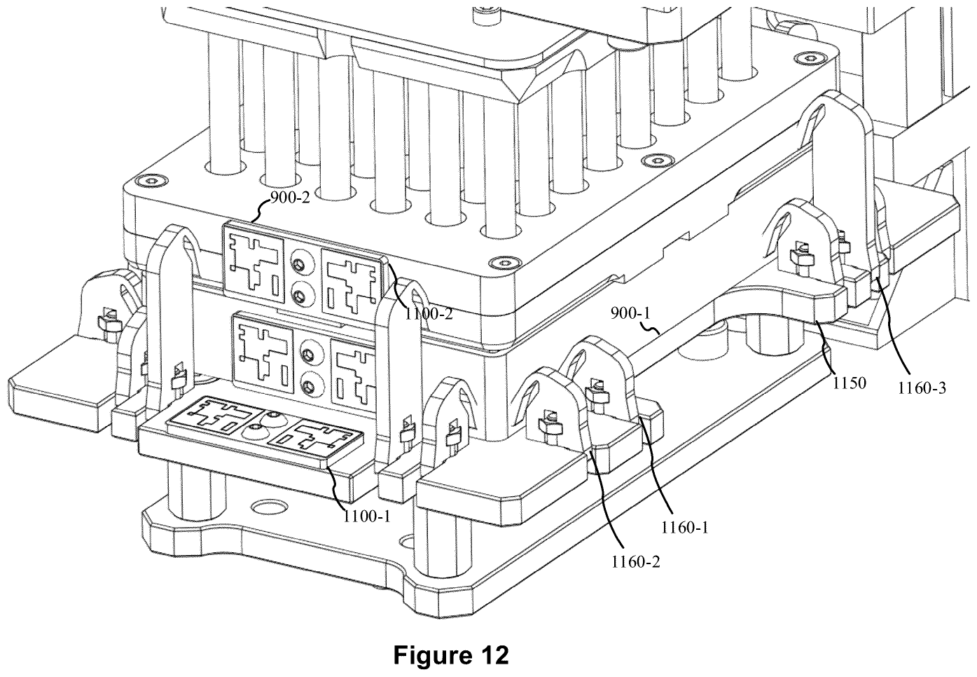

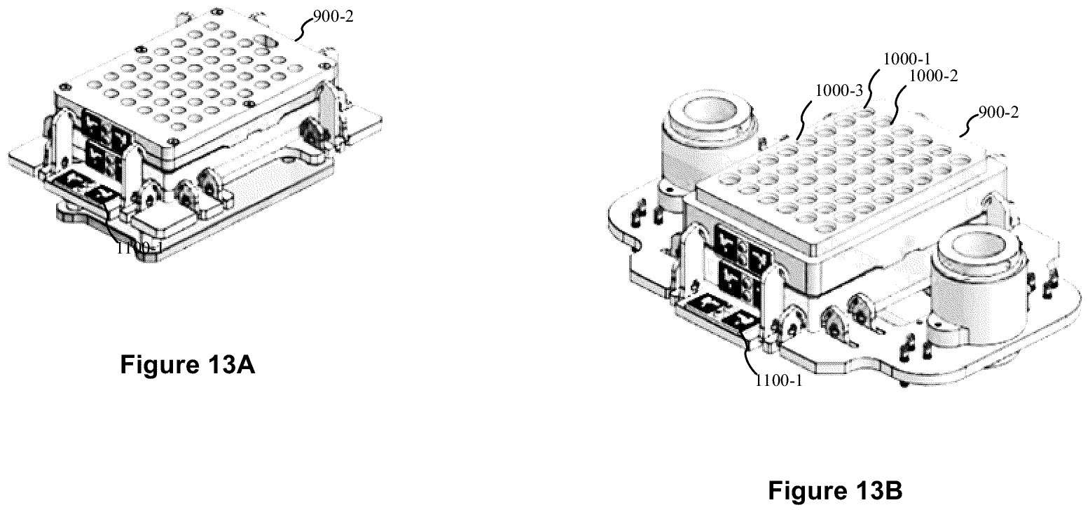

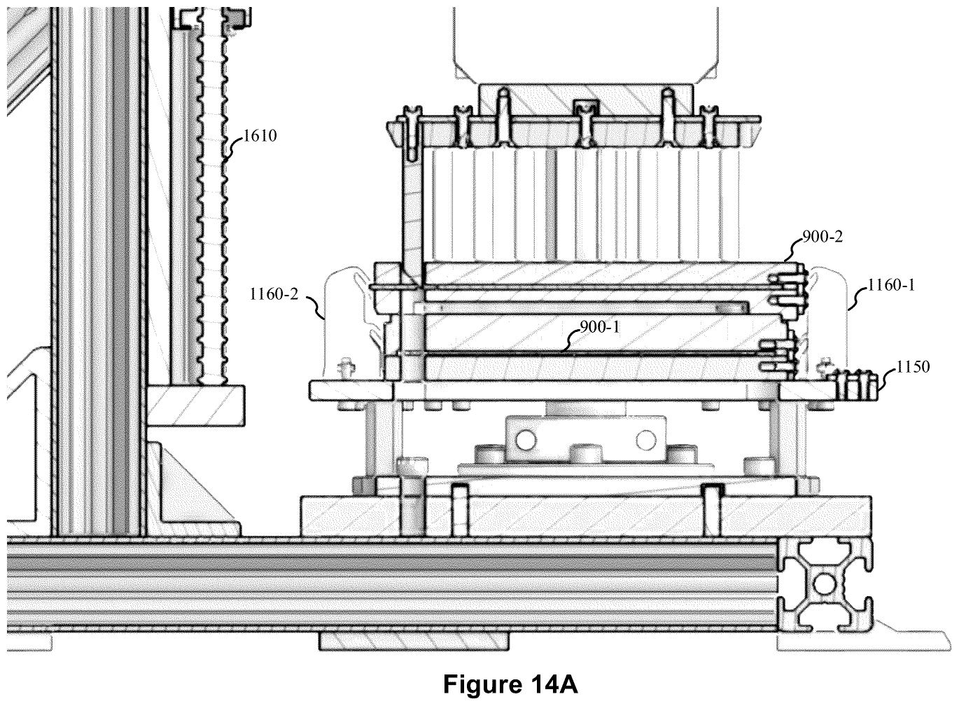

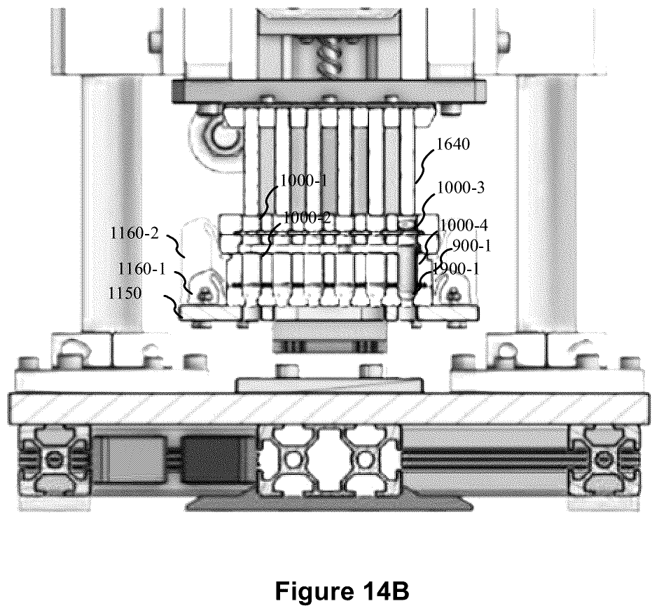

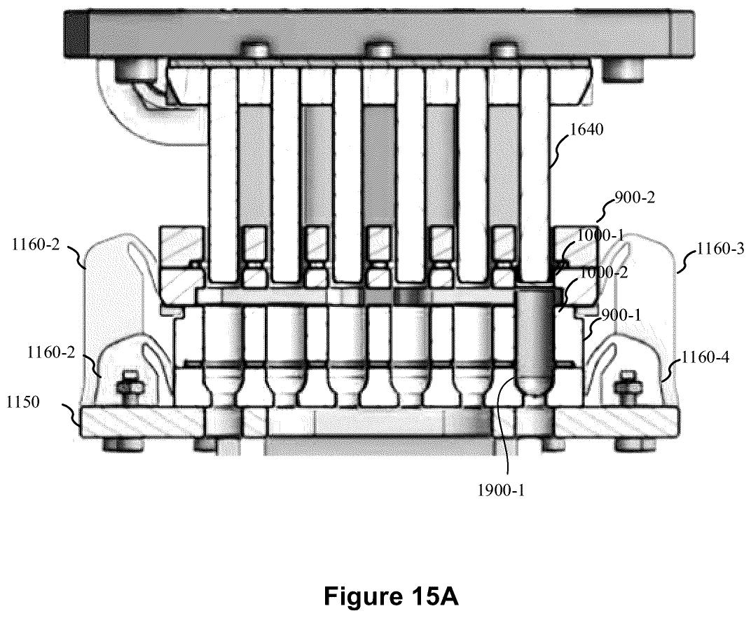

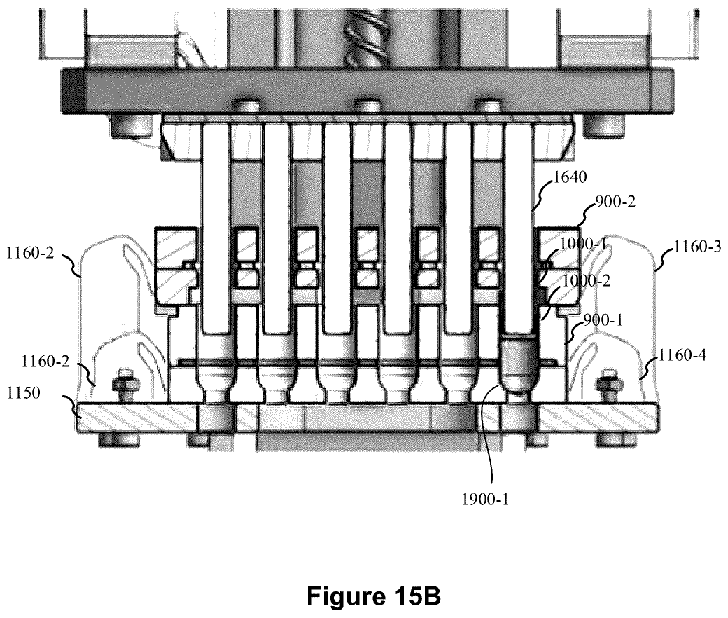

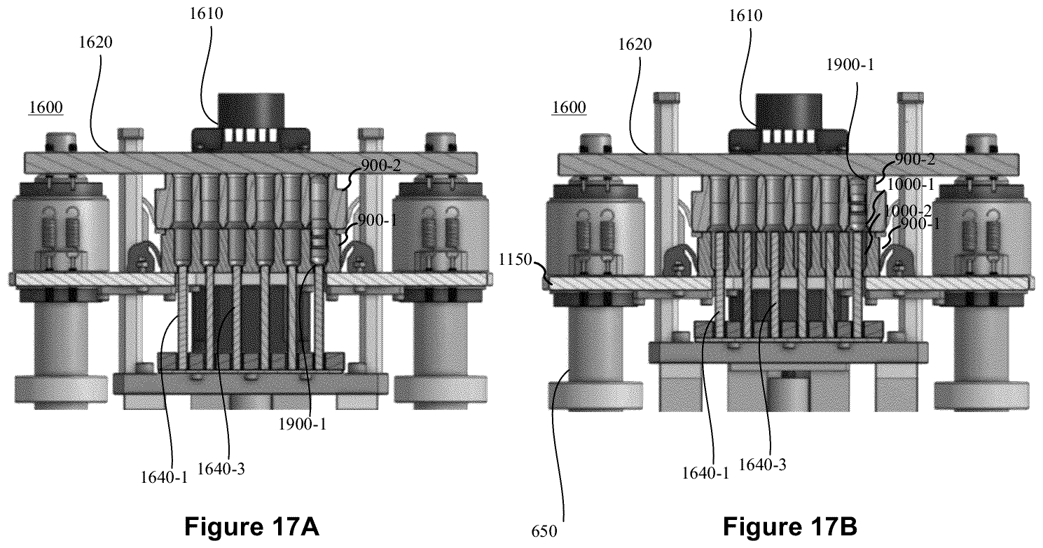

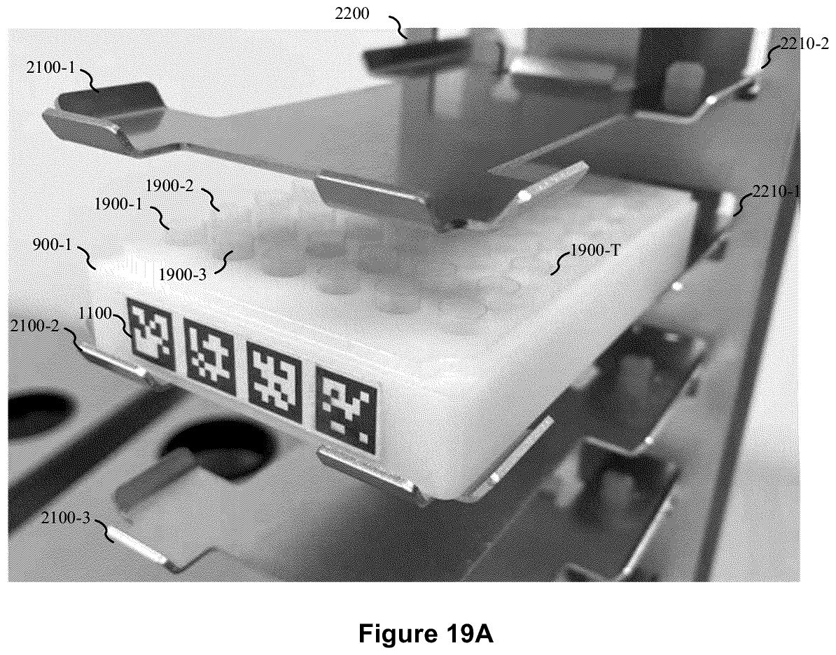

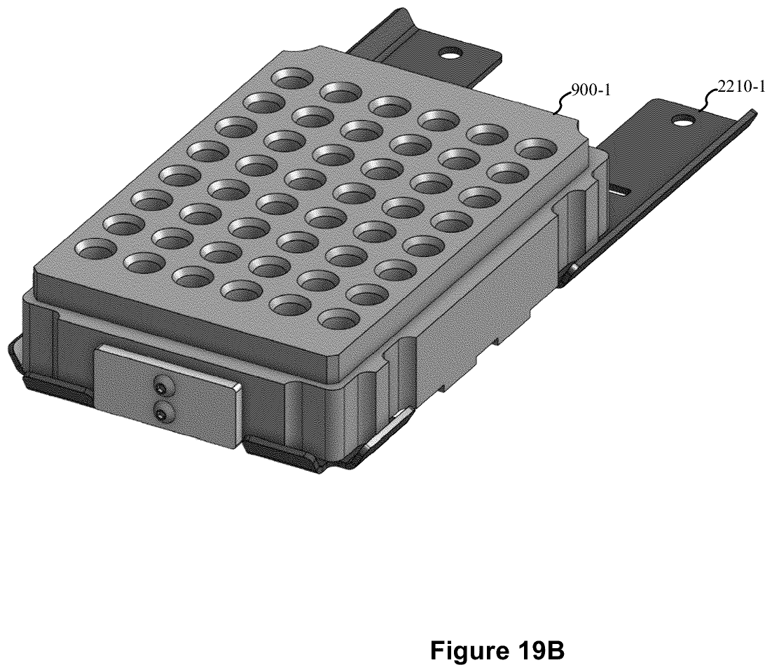

In some embodiments, the capsule assembly apparatus 300 includes a hopper (e.g., hopper 402 of FIG. 3, hopper 402 of FIG. 4, hopper 402 of FIG. 5, etc.), a dispenser (e.g., dispenser 420 of FIG. 3, dispenser 420 of FIG. 4, dispenser 420 of FIG. 5, dispenser 420 of FIG. 6, dispenser 420 of FIG. 7, etc.), one or more gate mechanisms (e.g., first gate mechanism 440-1 of FIG. 3, second gate mechanism 440-2 of FIG. 3, first gate mechanism 440-1 of FIG. 4, second gate mechanism 440-2 of FIG. 4, third gate mechanism 440-3 of FIG. 4, first gate mechanism 440-1 of FIG. 5, second gate mechanism 440-2 of FIG. 5, third gate mechanism 440-3 of FIG. 5, third gate mechanism 440-3 of FIG. 6, third gate mechanism 440-3 of FIG. 7, etc.), one or more actuation mechanisms, one or more actuation mechanisms, (e.g., first actuation mechanism 430-1 of FIG. 3, second actuation mechanism 430-2 of FIG. 3, first actuation mechanism 430-1 of FIG. 5, second actuation mechanism 430-2 of FIG. 5, second actuation mechanism 430-2 of FIG. 5, second actuation mechanism 430-2 of FIG. 7, etc.), one or more guide mechanisms (e.g., an issuance slide guide mechanism), one or more sensors (e.g., one or more two-dimensional pixelated detectors, such as an issuance camera), one or more trays (e.g., first tray 900-1 of FIG. 3, first tray 900-1 of FIG. 3, first tray 900-1 of FIG. 3, first tray 900-1 of FIG. 9A, second tray 900-2 of FIG. 9B, third tray 900-3 of FIG. 9C, first tray 900-1 of FIG. 10A, second tray 900-2 of FIG. 10B, third tray 900-3 of FIG. 10C, first tray 900-1 of FIG. 11A, second tray 900-2 of FIG. 11A, first tray 900-1 of FIG. 11A, second tray 900-2 of FIG. 11B, first tray 900-1 of FIG. 11C, second tray 900-2 of FIG. 11C, first tray 900-1 of FIG. 12, second tray 900-2 of FIG. 12, first tray 900-1 of FIG. 13A, second tray 900-2 of FIG. 13A, first tray 900-1 of FIG. 13B, second tray 900-2 of FIG. 13B, first tray 900-1 of FIG. 14A, second tray 900-2 of FIG. 14A, first tray 900-1 of FIG. 14B, second tray 900-2 of FIG. 14B, first tray 900-1 of FIG. 15A, second tray 900-2 of FIG. 15A, first tray 900-1 of FIG. 15B, second tray 900-2 of FIG. 15B, first tray 900-1 of FIG. 17A, second tray 900-2 of FIG. 17A, first tray 900-1 of FIG. 17B, second tray 900-2 of FIG. 17B, first tray 900-1 of FIG. 18B, first tray 900-1 of FIG. 19A, tray 900 of FIG. 19B, etc.), or a combination thereof.

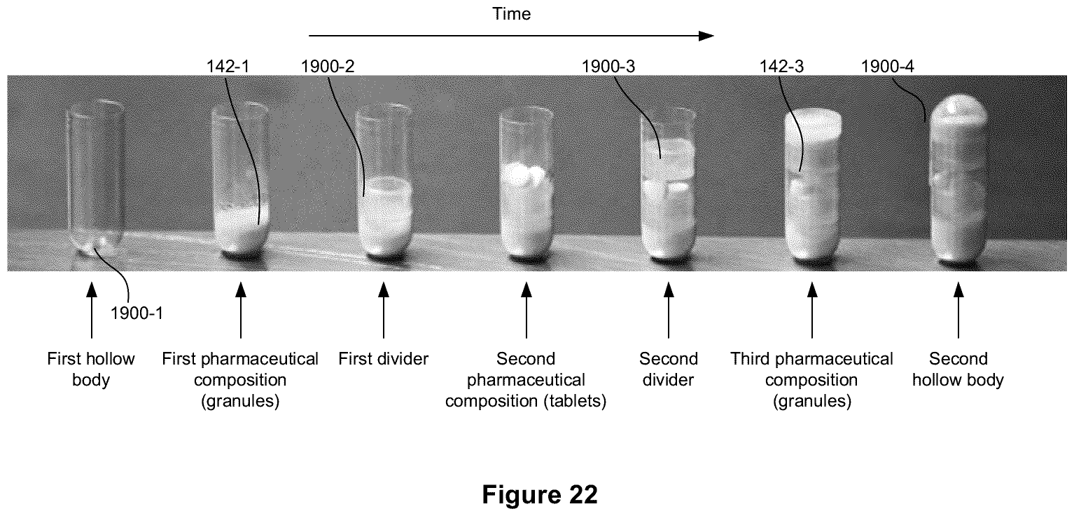

In some embodiments, the capsule assembly apparatus 300 is configured to automatically deposit a predetermined number of one or more solid dosage forms (e.g., of a predetermined size) in one or more bodies (e.g., first body 1900-1 of FIG. 14B, first body 1900-1 of FIG. 15A, first body 1900-1 of FIG. 15B, first body 1900-1 of FIG. 17B, first body 1900-1 of FIG. 19A, second body 1900-2 of FIG. 19A, third body 1900-3 of FIG. 19A, . . . , body T 1900-T of FIG. 19A, first body 1900-1 of FIG. 22, etc.), such as one or more capsule bodies 1900 accommodated by a capsule body tray 900 of the capsule assembly apparatus 300. In some embodiments, a capsule body includes a side wall and a base that is realized integrally with the side wall. For instance, in some embodiments, the capsule body is a three-dimensional monolithic structure. In some embodiments, the capsule body is rotationally symmetrical.

In some embodiments, the body 1900 is a hard shell body, which is utilized to assembly a hard shell capsule, in which the body includes in between 0% and 30% water weight, between 0% and 20% water weight, between 0% and 15% water weight, between 0% and 10% water weight, between 0% and 5% water weight, between 5% and 30% water weight, between 5% and 20% water weight, between 5% and 15% water weight, between 5% and 10% water weight, between 10% and 30% water weight, between 10% and 20% water weight, or between 10% and 15% water weight. In some embodiments, the body includes at least 0% water weight, at least 1% water weight, at least 2% water weight, at least 3% water weight, at least 4% water weight, at least 5% water weight, at least 6% water weight, at least 7% water weight, at least 8% water weight, at least 9% water weight, at least 10% water weight, at least 11% water weight, at least 12% water weight, at least 13% water weight, at least 14% water weight, at least 15% water weight, at least 16% water weight, at least 17% water weight, at least 18% water weight, at least 19% water weight, at least 20% water weight, at least 21% water weight, at least 22% water weight, at least 23% water weight, at least 24% water weight, at least 25% water weight, at least 26% water weight, at least 27% water weight, at least 28% water weight, at least 29% water weight, or at least 30% water weight. In some embodiments, the body includes at most 0% water weight, at most 1% water weight, at most 2% water weight, at most 3% water weight, at most 4% water weight, at most 5% water weight, at most 6% water weight, at most 7% water weight, at most 8% water weight, at most 9% water weight, at most 10% water weight, at most 11% water weight, at most 12% water weight, at most 13% water weight, at most 14% water weight, at most 15% water weight, at most 16% water weight, at most 17% water weight, at most 18% water weight, at most 19% water weight, at most 20% water weight, at most 21% water weight, at most 22% water weight, at most 23% water weight, at most 24% water weight, at most 25% water weight, at most 26% water weight, at most 27% water weight, at most 28% water weight, at most 29% water weight, or at most 30% water weight.

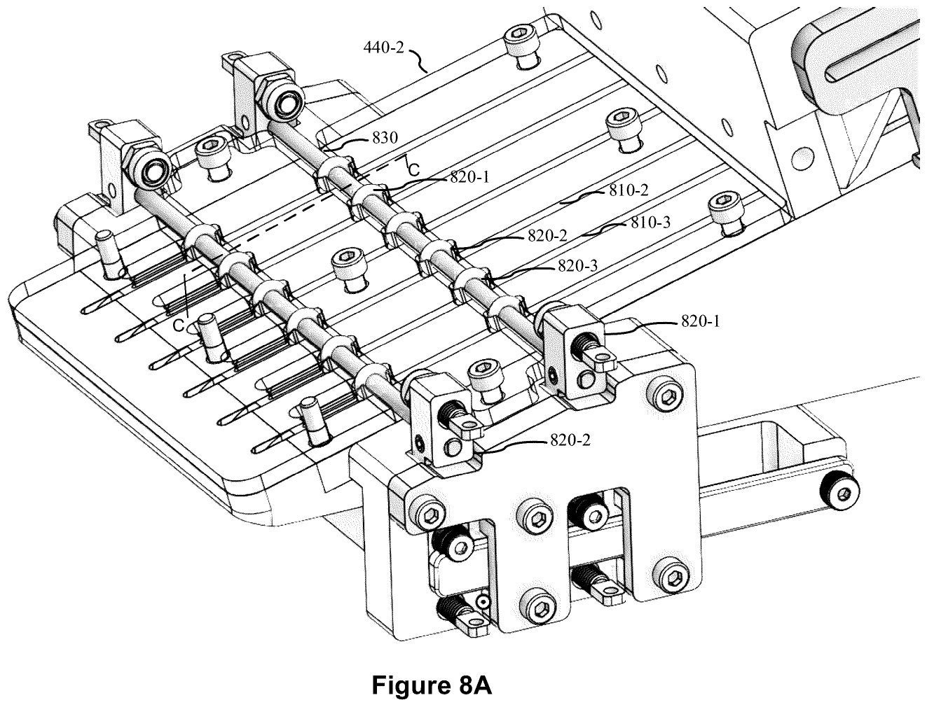

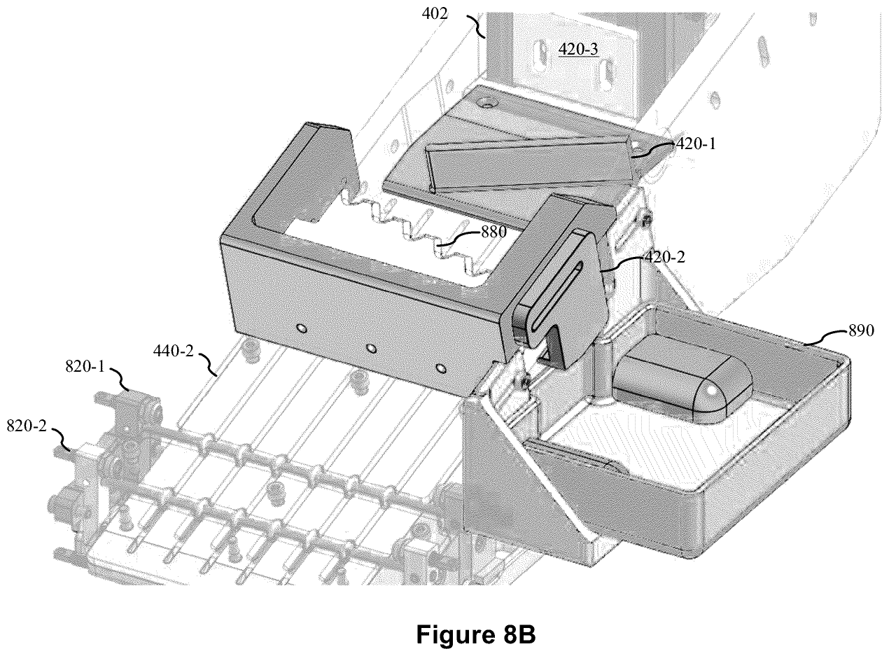

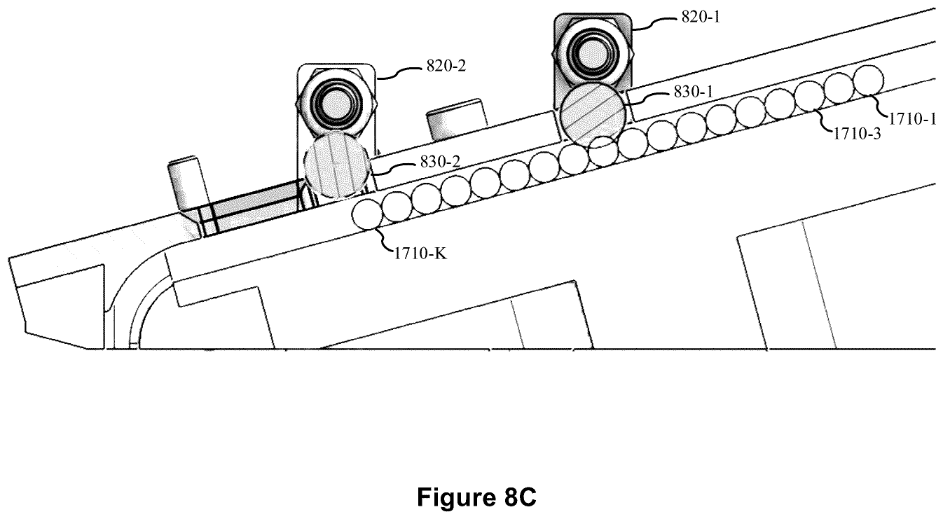

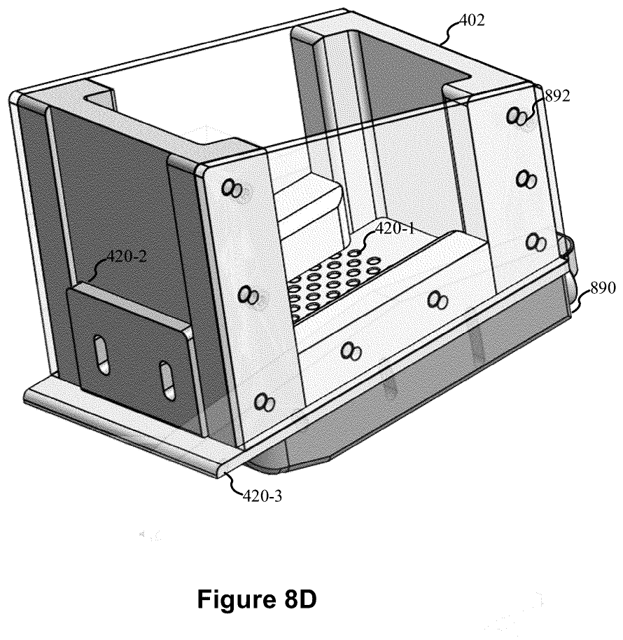

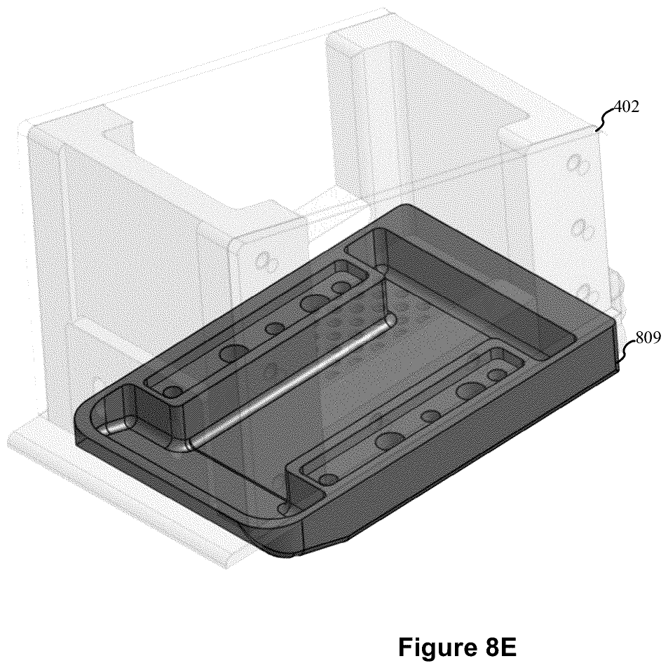

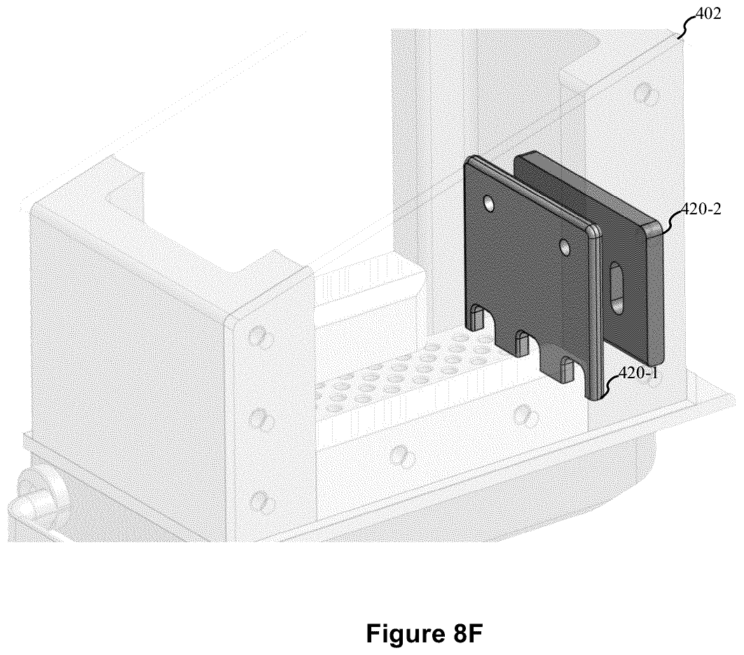

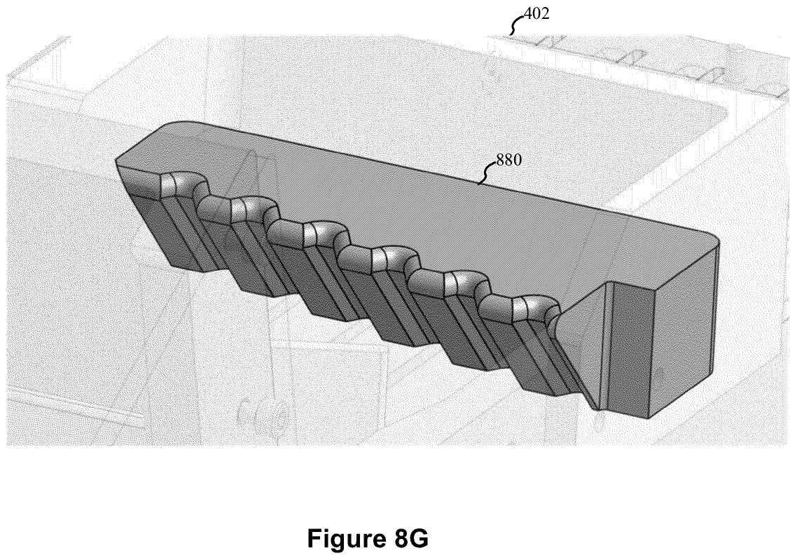

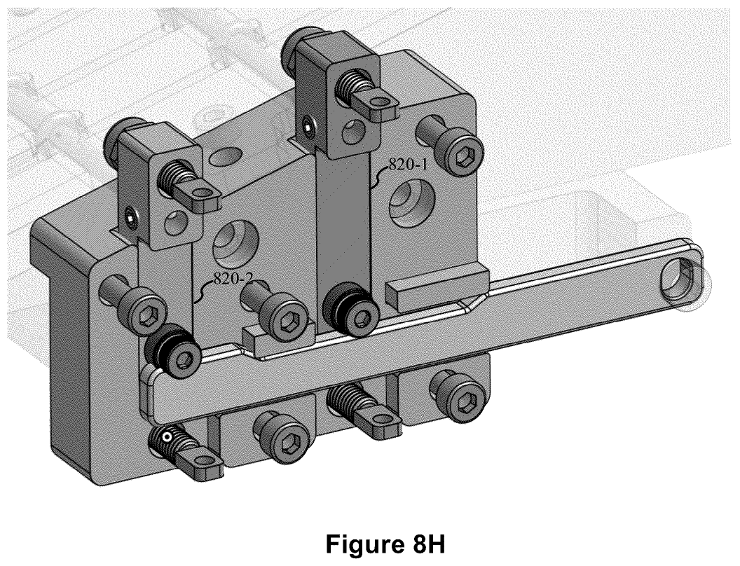

Referring briefly to FIG. 8C, in some embodiments, the solid dosage form (e.g., first solid dosage form 1710-1, third solid dosage form 1710-3, . . . solid dosage form K 1710-K of FIG. 8C) has a circular, or substantially circular, cross section, which allows for easing rolling of the solid dosage form through the capsule assembly apparatus. For instance, in some embodiments, the predetermined number of one or more solid dosage forms is one solid dosage form in each capsule body, two solid dosage forms in each capsule body, three solid dosage forms in each capsule body, four solid dosage forms in each capsule body, five solid dosage forms in each capsule body, six solid dosage forms in each capsule body, seven solid dosage forms in each capsule body, eight solid dosage forms in each capsule body, nine solid dosage forms in each capsule body, or ten solid dosage forms in each capsule body. In some embodiments, the predetermined number of one or more solid dosage forms is between one solid dosage form and 100 solid dosage forms, between 2 solid dosage forms and 50 solid dosage forms, between 2 solid dosage forms and 20 solid dosage forms, between 2 solid dosage forms and 10 solid dosage forms, between 2 solid dosage forms and 5 solid dosage forms, between 3 solid dosage forms and 50 solid dosage forms, between 3 solid dosage forms and 20 solid dosage forms, between 3 solid dosage forms and 10 solid dosage forms, between 3 solid dosage forms and 5 solid dosage forms, between 4 solid dosage forms and 50 solid dosage forms, between 4 solid dosage forms and 20 solid dosage forms, between 4 solid dosage forms and 10 solid dosage forms, between 4 solid dosage forms and 5 solid dosage forms, between 5 solid dosage forms and 50 solid dosage forms, between 5 solid dosage forms and 20 solid dosage forms, between 5 solid dosage forms and 10 solid dosage forms, between 10 solid dosage forms and 50 solid dosage forms, between 10 solid dosage forms and 20 solid dosage forms, or between 20 solid dosage forms and 50 solid dosage forms. In some embodiments, the predetermined number of one or more solid dosage forms is at least one solid dosage form in each capsule body, at least two solid dosage forms in each capsule body, at least three solid dosage forms in each capsule body, at least four solid dosage forms in each capsule body, at least five solid dosage forms in each capsule body, at least six solid dosage forms in each capsule body, at least seven solid dosage forms in each capsule body, at least eight solid dosage forms in each capsule body, at least nine solid dosage forms in each capsule body, at least ten solid dosage forms in each capsule body, at least 12 solid dosage forms in each capsule body, at least 15 solid dosage forms in each capsule body, at least 20 solid dosage forms in each capsule body, at least 25 solid dosage forms in each capsule body, at least 30 solid dosage forms in each capsule body, at least 35 solid dosage forms in each capsule body, at least 40 solid dosage forms in each capsule body, at least 45 solid dosage forms in each capsule body, at least 50 solid dosage forms in each capsule body, at least 75 solid dosage forms in each capsule body, or at least 100 solid dosage forms in each capsule body. In some embodiments, the predetermined number of one or more solid dosage forms is at most one solid dosage form in each capsule body, at most two solid dosage forms in each capsule body, at most three solid dosage forms in each capsule body, at most four solid dosage forms in each capsule body, at most five solid dosage forms in each capsule body, at most six solid dosage forms in each capsule body, at most seven solid dosage forms in each capsule body, at most eight solid dosage forms in each capsule body, at most nine solid dosage forms in each capsule body, at most ten solid dosage forms in each capsule body, at most 12 solid dosage forms in each capsule body, at most 15 solid dosage forms in each capsule body, at most 20 solid dosage forms in each capsule body, at most 25 solid dosage forms in each capsule body, at most 30 solid dosage forms in each capsule body, at most 35 solid dosage forms in each capsule body, at most 40 solid dosage forms in each capsule body, at most 45 solid dosage forms in each capsule body, at most 50 solid dosage forms in each capsule body, at most 75 solid dosage forms in each capsule body, or at most 100 solid dosage forms in each capsule body.

In some embodiments, a solid dosage form in the first plurality of solid dosage forms has a roundness in between 0.1 and 1, between 0.2 and 1, between 0.4 and 0.9, between 0.5 and 1, between 0.5 and 0.8, or 0.6 and 1. In some embodiments, the roundness of the solid dosage form is at least 0.1, at least 0.2, at least 0.3, at least 0.4, at least 0.5, at least 0.6, at least 0.7, at least 0.8, at least 0.9, or at least 1.0. In some embodiments, the roundness of the solid dosage form is at most 0.1, at most 0.2, at most 0.3, at most 0.4, at most 0.5, at most 0.6, at most 0.7, at most 0.8, at most 0.9, or at most 1.0.

In some embodiments, each solid dosage form in the first plurality of solid dosage forms includes a first size between 2 millimeter (mm) and 35 mm, between 2 mm and 30 mm, between 5 mm and 30 mm, between 5 mm and 20 mm, between 5 mm and 15 mm, between 2 mm and 10 mm, or between 5 mm and 10 mm. In some embodiments, each solid dosage form in the first plurality of solid dosage forms has a first size of at least 1 mm, at least 2 mm, at least 3 mm, at least 4 mm, at least 5 mm, at least 6 mm, at least 7 mm, at least 8 mm, at least 9 mm, at least 10 mm, at least 11 mm, at least 12 mm, at least 13 mm, at least 14 mm, at least 15 mm, at least 16 mm, at least 17 mm, at least 18 mm, at least 19 mm, at least 20 mm, at least 21 mm, at least 22 mm, at least 23 mm, at least 24 mm, at least 25 mm, at least 26 mm, at least 27 mm, at least 28 mm, at least 29 mm, at least 30 mm, at least 31 mm, at least 32 mm, at least 33 mm, at least 34 mm, or at least 35 mm. In some embodiments, each solid dosage form in the first plurality of solid dosage forms has a first size of at most 1 mm, at most 2 mm, at most 3 mm, at most 4 mm, at most 5 mm, at most 6 mm, at most 7 mm, at most 8 mm, at most 9 mm, at most 10 mm, at most 11 mm, at most 12 mm, at most 13 mm, at most 14 mm, at most 15 mm, at most 16 mm, at most 17 mm, at most 18 mm, at most 19 mm, at most 20 mm, at most 21 mm, at most 22 mm, at most 23 mm, at most 24 mm, at most 25 mm, at most 26 mm, at most 27 mm, at most 28 mm, at most 29 mm, at most 30 mm, at most 31 mm, at most 32 mm, at most 33 mm, at most 34 mm, or at most 35 mm. In some embodiments, the first size is a diameter of the solid dosage form. In some embodiments, the first size is a hydraulic diameter of the solid dosage form. In some embodiments, the first size is a width of the solid dosage form. In some embodiments, the first size is a characteristic dimension of the solid dosage form, such as a characteristic width of the solid dosage form. However, the present disclosure is not limited thereto.

In some embodiments, the capsule assembly apparatus deposits the same number of one or more solid dosage forms in each capsule in a plurality of capsules accommodated by a capsule body tray of the capsule assembly apparatus in an individual tray. In some embodiments, the capsule assembly apparatus deposits a different number of one or more solid dosage forms in each capsule of the plurality of capsules of the capsule body tray. For instance, in some embodiments, a workflow performed by the capsule assembly apparatus is configured to deposit one solid dosage form in each capsule body in the plurality of capsules. In some embodiments, to deposit more than one solid dosage form, the workflow is repeated until the predetermined number of one or more solid dosage forms has been deposited in each capsule body in the plurality of capsules.

In some embodiments, the capsule assembly apparatus is designed to operate autonomously, such as without human interference and with the assistance of an articulated handling robot. For instance, in some embodiments, once the hopper of the capsule assembly apparatus accommodates a first plurality of solid dosage forms (e.g., by having a human manufacturing operator or the articulated handling robot deposit the first plurality of solid dosage forms via the inlet of the hopper) for deposition in one or more capsule bodies via a workflow:

In some embodiments, the hopper 402 includes an inlet (e.g., inlet 404 of FIG. 3) that is configured for receiving a member in the first plurality of solid dosage forms. In some embodiments, the hopper includes an outlet that is configured for conveying the member in the first plurality of solid dosage forms towards a dispenser (e.g., dispenser 420 of FIG. 3, dispenser 420 of FIG. 6, etc.). For instance, in some embodiments, the outlet includes a tapered portion that narrows in a first direction (e.g., towards the dispenser), such as a funnel, such that the outlet is configured to direct the member in the first plurality of dosage forms towards the dispenser. In some embodiments, the roundness is determined by a degree of abrasion of a particle as shown by a sharpness of an edge portion. Additional details and information regarding the roundness is found at Bates et al., 1980, “Glossary of Geology, 2nd Edition”, American Geological Institute, 2, print, which is hereby incorporated by reference in its entirety for all purposes.

In some embodiments, the hopper 402 is configure such that the inlet is disposed at a first end portion of the hopper. In some embodiments, the outlet of the hoper is disposed at a second end portion of the hopper. In some embodiments, the second end portion of the hoper is opposite, or substantially opposite, of the first end portion of the hopper. In some embodiments, the second end portion is perpendicular to the first end portion. In some embodiments, the outlet of the hopper is located at the bottom end portion of the hopper. For instance, in some embodiments, the bottom end portion of the hopper includes a surface including a plurality of through holes that allow the member in the first plurality of solid dosage forms to fall through and don't clog the hooper. Accordingly, in some embodiments, the first end portion is raised in comparison to the second end portion of the hopper, which allows for the first plurality of dosage forms to flow towards the second end portion by gravitational forces. In some embodiments, the inlet is loaded from a first end portion (e.g., a rear end portion) of the capsule assembly apparatus, such as a side portion that is facing outwardly from the capsule assembly apparatus. In some such embodiments, the hopper is easily accessed by a manufacturing operator supervising an operation of the systems, methods, and apparatuses of the present disclosure, such as by a gate mechanism accommodated by the inlet in order to provides access to an interior of the hopper. Accordingly, in some embodiments, the hopper is configured so to be sealed with respect to the environment, which allows for restocking of the solid dosage forms. However, the present disclosure is not limited thereto. In some embodiments, an intermediate formulation of a medium deposited by the capsule assembly apparatus must be in solid dosage form. In some such embodiments, all solid dosage forms accommodated by the hopper must have the same size. Accordingly, in some such embodiments, the hopper is configured to provide uniform characteristics when conveying (e.g., feeding) the member in the first plurality of dosage forms, such as until the entire first plurality of dosage forms has been utilized by the capsule assembly apparatus. However, the present disclosure is not limited thereto.

In some embodiments, once a first plurality of solid dosage forms has been placed in the hopper (e.g., by an operator and/or the articulated handling robot), one or more solid dosage forms in the first plurality of solid dosage forms is pushed or traverses forward by a motion of an actuation mechanism, such as a vibration actuation mechanism. In some embodiments, the motion of the vibration actuation mechanism pushes the one or more solid dosage forms through a respective groove in a plurality of grooves of an issuance slide. In some embodiments, the one or more solid dosage forms then traverse (e.g., fall) into a dispenser. In some embodiments, the actuation mechanism is configured to cause the hopper to move in a translational direction with a frequency between 1 hertz (Hz) and 500 Hz, between 5 Hz and 300 Hz, between 10 Hz and 200 Hz, or between 75 Hz and 125 Hz. In some embodiments, the actuation mechanism 430 is configured to cause the hopper to move in a translational direction with a frequency of at least 1 Hz, at least 5 Hz, at least 10 Hz, at least 20 Hz, at least 30 Hz, at least 40 Hz, at least 50 Hz, at least 60 Hz, at least 70 Hz, at least 80 Hz, at least 90 Hz, at least 100 Hz, at least 110 Hz, at least 120 Hz, at least 130 Hz, at least 140 Hz, at least 150 Hz, at least 160 Hz, at least 170 Hz, at least 180 Hz, at least 190 Hz, at least 200 Hz, at least 210 Hz, at least 220 Hz, at least 230 Hz, at least 240 Hz, at least 250) Hz, at least 260 Hz, at least 270 Hz, at least 280 Hz, at least 290 Hz, at least 300 Hz, at least 310 Hz, at least 320 Hz, at least 330 Hz, at least 340 Hz, at least 350 Hz, at least 360 Hz, at least 370 Hz, at least 380 Hz, at least 390 Hz, at least 400 Hz, at least 410 Hz, at least 420 Hz, at least 430 Hz, at least 440 Hz, at least 450 Hz, at least 460 Hz, at least 470 Hz, at least 480) Hz, at least 490 Hz, or at least 500 Hz. In some embodiments, the actuation mechanism 430) is configured to cause the hopper to move in a translational direction with a frequency of at most 1 Hz, at most 5 Hz, at most 10 Hz, at most 20 Hz, at most 30 Hz, at most 40 Hz, at most 50 Hz, at most 60 Hz, at most 70 Hz, at most 80 Hz, at most 90 Hz, at most 100 Hz, at most 110 Hz, at most 120 Hz, at most 130 Hz, at most 140 Hz, at most 150 Hz, at most 160 Hz, at most 170 Hz, at most 180 Hz, at most 190 Hz, at most 200 Hz, at most 210 Hz, at most 220) Hz, at most 230 Hz, at most 240) Hz, at most 250) Hz, at most 260 Hz, at most 270) Hz, at most 280 Hz, at most 290 Hz, at most 300 Hz, at most 310 Hz, at most 320 Hz, at most 330 Hz, at most 340) Hz, at most 350 Hz, at most 360 Hz, at most 370 Hz, at most 380 Hz, at most 390 Hz, at most 400 Hz, at most 410 Hz, at most 420 Hz, at most 430 Hz, at most 440) Hz, at most 450 Hz, at most 460 Hz, at most 470 Hz, at most 480 Hz, at most 490 Hz, or at most 500 Hz.

In some embodiments, the capsule assembly apparatus further includes a transport mechanism that is disposed at a lower end portion of the hopper. In some embodiments, the transport mechanism is configured to covey the member in the first plurality of solid dosage forms from a portion of the hopper towards at least the outlet of hopper. For instance, in some embodiments, the transport mechanism is configured to convey the member from the inlet of the hopper towards at least the outlet of the hopper, such as by ejecting the member from the outlet of the hopper. However, the present disclosure is not limited thereto.

In some embodiments, the capsule assembly apparatus includes one or more gate mechanism, two or more gate mechanisms, three or more gate mechanisms, or five or more gate mechanisms. For instance, in some embodiments, the hopper includes a gate mechanism (e.g., third gate mechanism 440-3 of FIG. 5) that is configured to restrict a flow of the member in the first plurality of solid dosage forms.

For instance, in some embodiments, the capsule assembly apparatus further includes a first gate mechanism disposed adjacent to the outlet of the hopper. In some embodiments, the first gate mechanism is configured to control access by the member in the first plurality of solid dosage forms through the outlet of the hopper. In some embodiments, the first gate mechanism includes sieve that is utilized to orient the member in a first direction. For instance, in some embodiments, the first gate mechanism includes a plurality of through holes having diameter between 0.05 millimeter (mm) and 10 mm, between 0.05 mm and 6 mm, or between 0.1 mm and 3 mm. In some embodiments, the diameter of a through hole in the plurality of through holes of the third gate mechanism is at least 0.05 mm, at least 0.1 mm, at least 0.2 mm, at least 0.5 mm, at least 1 mm, at least 1.5 mm, at least 2 mm, at least 2.5 mm, at least 3 mm, at least 3.5 mm, at least 4 mm, at least 4.5 mm, at least 5 mm, at least 5.5 mm, at least 6 mm, at least 6.5 mm, at least 7 mm, at least 7.5 mm, at least 8 mm, at least 8.5 mm, at least 9 mm, at least 9.5 mm, or at least 10 mm. In some embodiments, the diameter of a through hole in the plurality of through holes of the first gate mechanism is at most 0.05 mm, at most 0.1 mm, at most 0.2 mm, at most 0.5 mm, at most 1 mm, at most 1.5 mm, at most 2 mm, at most 2.5 mm, at most 3 mm, at most 3.5 mm, at most 4 mm, at most 4.5 mm, at most 5 mm, at most 5.5 mm, at most 6 mm, at most 6.5 mm, at most 7 mm, at most 7.5 mm, at most 8 mm, at most 8.5 mm, at most 9 mm, at most 9.5 mm, or at most 10 mm.

In some embodiments, the first gate mechanism is disposed at a lower end portion of the hopper. For instance, in some embodiments, the first gate mechanism is disposed at the bottom end portion of the hopper. Accordingly, in some such embodiments, the a lower end surface of the hopper includes a plurality of through holes, such as a sieve, that has a first size less than a second size of a solid dosage form, which allows fragments of the solid dosage form to fall through the through holes of the first gate mechanism, and not clogging the capsule assembly apparatus. Furthermore, in some embodiments, the first gate mechanism includes one or more openings and/or one or more protrusions, each of which is configured to retard and/or arrest a flow of the solid dosage form between the hopper and the dispenser. However, the present disclosure is not limited thereto.

In some embodiments, the capsule apparatus mechanism includes a second gate mechanism (e.g., second gate mechanism 440-2 of FIG. 3, second gate mechanism 440-2 of FIG. 4, second gate mechanism 440-2 of FIG. 5, second gate mechanism 440-2 of FIG. 6, second gate mechanism 440-2 of FIG. 7, second gate mechanism 440-2 of FIG. 8A, second gate mechanism 440-2 of FIG. 8B, etc.). In some embodiments, the second gate mechanism is disposed interposing between the outlet of the hopper 402 and the dispenser 420. In some embodiments, the second gate mechanism is configured to control the conveying of the member in the first plurality of solid dosage forms, such as a speed of the member, an orientation of the member, a spacing between the member and another solid dosage form, or a combination thereof. In some embodiments, the second gate mechanism includes a first cam mechanism (e.g., first cam mechanism 820-1 of FIG. 8A) that is configured to control the conveyance of the member in the first plurality of solid dosage forms received by the channel in the one or more channels of the second gate mechanism. In some embodiments, the first cam mechanism includes a bar (e.g., bar 830 of FIG. 8A) that is configured to extend over a portion of each channel in the one or more channels 810 of the second gate mechanism. In some embodiments, the bar includes an annular protrusion that extends outwardly (e.g., radially) from a surface of the bar, which is configured to enter a portion of a channel of second gate mechanism. As a non-limiting example, in some embodiments, the annular protrusion includes an o-ring. In some embodiments, the annular protrusion is sized such that when the cam mechanism is in an OPEN state, an edge portion of the annular protrusion is at a first depth of the channel, and when the cam mechanism is in a CLOSED state the annular protrusion is at a second depth of the channel. In some embodiments, the first depth allows for the solid dosage form to pass through the channel past the cam mechanism, and the second depth prohibits the passing. However, the present disclosure is not limited thereto. In some embodiments, the second gate mechanism includes a second cam mechanism (e.g., second cam mechanism 820-2 of FIG. 8A). In some embodiments, the second cam mechanism is configured to control the conveying of the member in the first plurality of solid dosage forms discharged by the channel in the one or more channels of the first gate mechanism. In some embodiments, the first cam mechanism and the second cam mechanism collectively utilize a second actuation mechanism (e.g., second actuation mechanism 430-2 of FIG. 3, second actuation mechanism 430-2 of FIG. 4, second actuation mechanism 430-2 of FIG. 5, second actuation mechanism 430-2 of FIG. 7, etc.). Accordingly, in some such embodiments, the second gate mechanism allows for receiving a corresponding plurality of solid dosage forms for each channel in the one or more channels of the second gate mechanism. As a non-limiting example, in some embodiments, the second gate mechanism is configured to singulate a predetermined number of solid dosage forms (e.g., at least 8 solid dosage forms, at least 10 solid dosage forms, at least 15 solid dosage forms, etc.) in each channel. In some embodiments, the first cam mechanism and the second cam mechanism are utilized in an alternating fashion (e.g., the first cam mechanism is configured in an OPEN state when the second cam mechanism is configured in a CLOSED state) to actuate the second gate mechanism, which ensures that only a predetermined number of solid dosage forms is discharged at the second end portion opposite of the dispenser. For instance, in some embodiments, a distance between the first cam mechanism and the second cam mechanism defines the predetermined number of solid dosage forms discharged by the second gate mechanism and, therefore, the dispenser. In some embodiments, the second actuation mechanism includes a linear actuator. As a non-limiting example, in some embodiments, the second actuation mechanism includes at least two vertical bars, in which each cam mechanism 820 is coupled to a vertical bar in the at least two vertical bars, that further include a bearing (e.g., ball bearing) at an end portion of the vertical bar that is configured to traverse along a horizontal cam track of the second actuation mechanism. Accordingly, as the horizontal cam track is forced to move in a first or second direction, each vertical bar moves to either open or close a corresponding cam mechanism. In some embodiments, the second actuation mechanism is configured to cause movement of the dispenser, such as in a first direction and/or a second direction. In some embodiments, the first actuation mechanism is configured to cause movement in a direction parallel to that of the motion caused by the second actuation mechanism. However, the present disclosure is not limited thereto. Accordingly, by utilizing the second actuation mechanism for both the dispenser and the second gate mechanism, the capsule assembly apparatus of the present disclosure does not require a further actuator mechanism to cause movement of the first cam mechanism, the second cam mechanism, or the dispenser. Furthermore, in some embodiments, the second gate mechanism prevents breakage of the solid dosage forms, such as by restricting an orientation of the member in the solid dosage form and/or controlling a velocity of the solid dosage form through the second gate mechanism. However, the present disclosure is not limited thereto. In some embodiments, the second gate mechanism provides an overflow control, which prevents excess solid dosage forms from being received by a tray.

In some embodiments, the dispenser includes a set of one or more grooves (e.g., vertical grooves) that accommodates the one or more solid dosage forms that will be used in a single deposition process. In some embodiments, the dispenser is monitored by a solid dosage form issuance camera. In some embodiments, the solid dosage form issuance camera is configured to capture an image of capsule assembly apparatus, such as a capture an image of the dispenser and/or the hopper.

In some embodiments, the outlet is disposed at a position at or above of the maximum height of the respective through hole in the plurality of through holes of the dispenser. Accordingly, by having the outlet disposed at or above the maximum height of the respective through hole, the capsule assembly is capable of utilize gravity to convey the solid dosage form.

In some embodiments, a vision module of a computer system 100 evaluates the picture. In some embodiments, this evaluating includes counting a number of tables in the one or more solid dosage forms that have been issued in the dispenser. In some embodiments, if a threshold number of issued solid dosage forms is not satisfied, the actuation mechanism continues the motion to vibrate, thus adding additional solid dosage forms from the plurality of tables in the dispenser, until the threshold number of issued solid dosage forms is satisfied. In some embodiments, this evaluating is performed by one or more computational models (e.g., stored by the computer system 100 of FIG. 2). Accordingly, in some embodiments, the present disclosure provides a fast, optical verification for ensuring accurate and precise assembling of the capsules.

In some embodiments, the dispenser moves in a traverse motion, such as back and forth, for a pre-determined number of passes across a length of the capsule assembly apparatus. For instance, in some embodiments, two such passes are enough for the deposition of the one or more solid dosage forms, such that this movement deposits one solid dosage form in the one or more solid dosage forms into each metering hole of a metering plate of the capsule assembly apparatus. However, the present disclosure is not limited thereto. In the exemplary embodiments of the apparatus, the plurality of metering holes is formed perpendicular to a planar surface of the apparatus. However, the present invention is not limited thereto. In some embodiments, each plurality of metering holes in the plurality of metering holes is formed at a predetermined angle to a planar surface of the apparatus. Similarly, in some embodiments of the apparatus, the plurality of metering holes is formed as a plurality of cylindrical holes: however, the present invention is not limited thereto. In some embodiments, the plurality of metering holes is formed in a plurality of frustums or funnels.

In some embodiments, a gap is formed between various moving members or members adjacent to a moving member. In such embodiments, a height of the gap is configured so that the clearance between components is sufficiently large to prevent galling yet sufficiently small to prevent the solid dosage form from entering the gap. Such gaps can exist between, but are not limited to, the hopper and the dispenser, the dispenser and the tray, or a combination thereof.

In some embodiments, once each metering hole accommodates a solid dosage form, a gate placed below each metering hole opens and the solid dosage form fall into a respective capsule body accommodated in a capsule body tray that is placed under the capsule assembly apparatus. In some embodiments, the tray

In some embodiments, the gate mechanism includes a shutter plate (e.g., shutter plate 1320 of FIG. 7B). In some embodiments, the shutter plate is provided above or below the metering plate. In some embodiments, the shutter plate is configured to be horizontally driven in a reciprocation with dispenser. For instance, in some embodiments, the shutter plate includes a plurality of through holes arranged respectively so as to face the openings of the tray and/or the holes of the metering plate when the shutter plate is moved in a first direction. In some embodiments, the shutter plate closing the capsule holding holes when the shutter plate is moved in a second direction. In some embodiments, the through holes of the shutter plate are arranged respectively to face the openings of the tray and/or the holes of the metering plate when the dispenser is proximate to an end portion of the capsule apparatus, such as an end portion of the metering plate. However, the present disclosure is not limited thereto. In some embodiments, the gate mechanism further includes a fixed plate (e.g., fixed plate 1330 of FIG. 7B). In some embodiments, the fixed plate is disposed below the shutter plate and the metering plate. In some embodiments, the fixed plate provides a further metering mechanism of the gate mechanism, thus at least preventing unwanted spillage of the solid dosage form. For instance, in some embodiments, the fixed gate includes a plurality of through holes that substantially aligns with the plurality of through holes of the metering plate. As such, in some embodiments, when the shutter plate is moved to a first (e.g., OPEN) position, trace amount of material (e.g., powder, such as powder that breaks off of a solid dosage form), the trace amount of ingredients blocked by the fixed plate will slide over to the through holes of the fixed gate. Accordingly, the fixed gate ensures that the trace amount falls into the capsule body (e.g., instead of outside of the capsule body), again preventing spillage. However, the present disclosure is not limited thereto.

In some embodiments, this falling completes the deposition process at the capsule assembly apparatus. In some embodiments, the articulated handling robot retrieves the capsule body tray and take the capsule body tray to a next step in the assembly process.

Additional details and information regarding a metering plate or a gate mechanism is found at United States Pate Publication no.: 2019/0016048 A1, “Systems and Methods for Designing and Manufacturing Multi-Compartment Capsules,” published Jan. 17, 2019; U.S. Pat. No. 11,142,353 B2, entitled “Automated Batch Filling Apparatus,” published Oct. 12, 2021, each of which is hereby incorporated by reference in its entirety for all purposes.

In some embodiments, the capsule assembly apparatus also determines a number of leftover solid dosage forms that remain in one or more portions of the capsule assembly apparatus after the completing of the workflow (e.g., deposition task), such as a number of solid dosage forms retained by the hopper, the dispenser, or a gate mechanism of the capsule assembly apparatus. In some embodiments, this leftover intermediate formulation in the plurality of solid dosage forms is collected in a bin of the capsule assembly apparatus, such as a bin of FIG. 8B located below an actuation mechanism or the gate mechanism. However, the present disclosure is not limited thereto.

In some embodiments, the capsule assembly apparatus varies the number of deposited solid dosage forms by repeating the aforementioned workflow (e.g., deposition process). In some embodiments, the capsule assembly apparatus performs multiple workflow on the same capsule body tray. In this way, with each performance of the workflow, one more solid dosage forms in the plurality of solid dosage forms will be deposited into each capsule body.

In some embodiments, the capsule assembly apparatus is designed to accommodate a single configuration of an intermediate formulation in solid dosage form. Accordingly, in some such embodiments, if the intermediate formulation must be changed (e.g., from assembling the capsule using a first plurality of solid dosage forms to a second plurality of solid dosage forms different than the first plurality of solid dosage forms), then one or more portions of the capsule assembly apparatus that is in contact with the first plurality of solid dosage forms must be disassembled and/or cleaned. In some embodiments, some or all of the capsule assembly apparatus includes, or contains, one or more materials that is approved by the United States Food and Drug Administration (FDA) for the assembly of capsules. In particular, in some such embodiments, the one or more portions of the capsule assembly apparatus that come in contact with the plurality of solid dosage forms includes 316L stainless steel or acetal copolymer. In this way, in some such embodiments, the capsule assembly apparatus allows for rapidly being disassembled and re-assembled, enabling the possibility of quick changeovers for cleaning or process tuning at the capsule assembly apparatus.

In some embodiments, the dispenser is a three-dimensional monolithic body, which prevents clogging of the dispenser and/or breakage of the solid dosage form. However, the present disclosure is not limited thereto. For instance, in some embodiments, the dispenser includes a cover (e.g., cover 660 of FIG. 6). In some embodiments, the cover is configured to overlay a portion (e.g., an interior) of each through hole that is exposed (e.g., accessible from a surface of the dispenser) while protecting the through hole 670 of the dispenser from contamination.

In some embodiments, the second gate mechanism includes a door mechanism (e.g., door mechanism 420-2 of FIG. 8B) that controls the flow of the solid dosage forms into an overflow bin (e.g., bin 890 of FIG. 8B), which prevents clogging of the dosage forms entering the dispenser, such as at a front-end portion of the grooves extending from an upper end portion of the dispenser towards the outlet of the hopper of the dispenser.

In some embodiments, the dispenser further includes a surface (e.g., surface 880 of FIG. 8B) extending from an upper end portion of the dispenser towards the outlet of the hopper. In some embodiments, the surface includes a plurality of grooves. Each groove in the plurality of grooves includes a third terminal end portion adjacent to a corresponding first terminal end portion of a respective through hole. For instance, referring to FIG. 8B, the surface includes an angled surface configured to directs the solid dosage form coming out of the hopper towards the dispenser of the capsule assembly apparatus. Accordingly, in some embodiments, the surface includes the plurality of particularly shaped grooves that act as funnels, directing the solid dosage forms into the through holes of the dispenser. Furthermore, in some embodiments, the plurality of grooves ensure that the solid dosage forms align with the through holes, without clogging or jamming the capsule assembly apparatus.

Referring to FIG. 6 and FIG. 7, in some embodiments, the capsule assembly apparatus includes one or more guide mechanisms (e.g., guide mechanism 650 of FIG. 6), such as one or more skis and a guide bar that is configured to guiding the linear motion of the dispenser by way of the guide mechanism. In some embodiments, the dispenser is pushed in a traverse motion, such as back and forth across a length of the capsule assembly apparatus, by a linear actuator 420-2 of the capsule assembly apparatus, such as through a pin mount bar and a pin bolted to the dispenser. In some embodiments, by using the pin, the linear actuator does not need to be perfectly aligned to the dispenser. Furthermore, in some embodiments, the pin mount bar also serves as a gate opener bar, in that the pin mount bar pushes the gate mechanism open, releasing the solid dosage forms and allowing them to fall into the underlying capsules.

Referring to FIG. 9A through FIG. 19B, one or more capsule trays 900 are provided. In some embodiments, the tray includes a plurality of openings. Each opening in the plurality of openings is configured to accommodate both a body and the member in the first plurality of solid dosage forms. In some embodiments, each opening in the plurality of openings is configured to substantially align directly below the second terminal end portion of a respective through hole in the plurality of through holes.

In some embodiments, the capsule assembly apparatus further includes a third gate mechanism 430-3 disposed interposing between the dispenser and the tray. In some embodiments, the third gate mechanism is configured to control the discharge of the member in the first plurality of solid dosage forms from the dispenser. For instance, in some embodiments, the third gate mechanism includes a metering plate. In some embodiments, the third gate mechanism is positioned directly below the dispenser. In some embodiments, the third gate mechanism is fixed a portion of the dispenser. However, the present disclosure is not limited thereto. Accordingly, in some embodiments, the metering plate includes a plurality of openings. In some embodiments, the plurality of openings is equally spaced apart in an array (e.g., a circular array, a rectangular array, an irregular array, etc.) directly below the second terminal end portion of a through hole of the dispenser. Furthermore, in some embodiments, the plurality of openings of the third gate mechanism is an equal number as the plurality of openings of the tray. However, the present disclosure is not limited thereto. In some embodiments, an opening in the plurality of openings of the third gate mechanism is sized to receive a single solid dosage form. For instance, in some embodiments, the dispenser traverses in a first direction of the third gate mechanism between successive openings in the plurality of openings until the second terminal end portion of the through hole of the dispenser is aligned with an opening of the third gate mechanism.

More particularly, FIG. 9A through FIG. 22C illustrate various embodiments of one or more capsules trays that is used by an articulated handling robot to facilitate assembly of a plurality of capsules, each of which accommodates one or more solid dosage forms. Referring briefly to FIG. 9A and FIG. 10A, a first capsule tray, or a capsule body tray, for accommodating a plurality of capsule bodies is provided. Referring briefly to FIG. 9B and FIG. 10B, a second tray for accommodating a plurality of dividers, also referred to herein as a divider tray, is provided. Referring to FIG. 9C and FIG. 10C, a third tray for accommodating a plurality of capsule caps, also referred to herein as a cap tray, is provided.

In some embodiments, each opening (e.g., opening 1000 of FIG. 9a, opening 1000 of FIG. 9B, opening 1000 of FIG. 10C, etc.) in the plurality of openings of the tray is individually spaced at a predetermined interval along a dimension of the tray. In some embodiments, the predetermined interval is defined by a spacing between adjacent through holes in the plurality of through holes of the dispenser. However, the present disclosure is not limited thereto.

In some embodiments, the capsule assembly further includes a third actuation mechanism configured to control a movement of the tray or the dispenser in a linear direction. In some embodiments, the third actuation mechanism is configured to reveal a portion of the tray, which allows the tray to be removed from the capsule assembly apparatus and/or received by the capsule assembly apparatus.

In some embodiments, a surface of the tray includes a two- or three-dimensional indicium (e.g., two- or three-dimensional indicium 1100 of FIG. 9A, two- or three-dimensional indicium 1100 of FIG. 9B, two- or three-dimensional indicium 1100 of FIG. 9C, two- or three-dimensional indicium 1100 of FIG. 11C, two- or three-dimensional indicium 1100 of FIG. 12, etc.). For instance, in some embodiments, the two- or three-dimensional indicium includes one or more alphanumeric characters, one or more geometric figures, one or more bar codes (e.g., a universal produce number code (UPC)), one or more data matrix codes (e.g., one or more quick response (QR) codes), one or more logos, or combinations thereof. In some embodiments, the two- or three-dimensional indicium includes an impression, a ridge, or both. For instance, in some such embodiments, the QR code provides a two-dimensional matrix code that stores data information designed to be evaluated by a two-dimensional pixelated detector. For instance, in some embodiments, the QR code includes a plurality of modules of a first color, such as black, arranged in a square pattern on a background of a second color different than the first color, such as white. In some embodiments, the two- or three-dimensional indicium is a code structure on the tray that is readable or detectable by a sensor, for example by two-dimensional pixelated detectors of the capsule assembly apparatus.

Referring briefly to FIG. 10A through FIG. 10C, differences in function between the three types of trays 900 is seen by comparing respective cross-section views. For instance, in some embodiments, each opening in the plurality of openings includes a second size at a first end portion of the tray and a third size at a second end portion of the tray. For instance, referring to FIG. 10A, in some embodiments, the first end portion is an upper end portion of the tray, the second portion is a lower end portion of the tray, and the first size is greater than the second size. However, the present disclosure is not limited thereto. For instance, in some embodiments, referring briefly to FIG. 10C, the first end portion is the upper end portion of the tray, the second portion is the lower end portion of the tray, and the first size is less than the second size. Moreover, in some embodiments, a first size of each solid dosage form in the first plurality of solid dosage forms is equal to or less than the second size of each opening and greater than the third size of each opening.

In some embodiments, the hopper, the dispenser, the tray, or a combination thereof includes a transparent or translucent material. Accordingly, by having the hopper the hopper, the dispenser, the tray, or a combination thereof includes a transparent or translucent material the capsule assembly apparatus allows for visual inspection, such as to ensure delivery of the member in the first plurality of solid dosage forms.

Referring to FIG. 10A through 10C, cross-sectional views of various capsule trays are provided. More particularly, referring briefly to FIG. 10A, a first cross-sectional view of the body tray is provided. Referring briefly to FIG. 10B, a second cross-sectional view of the divider tray is provided. Referring briefly to FIG. 10C, a third cross-sectional view of the cap tray is provided.

Referring to FIG. 11A through 11C, in some embodiments, a set of trays (e.g., two trays) is accommodated by a docking station (e.g., docking station 1150 of FIG. 11A, docking station 1150 of FIG. 11B, docking station 1150 of FIG. 11C, docking station 1150 of FIG. 12, docking station 1150 of FIG. 13A, docking station 1150 of FIG. 11B, docking station 1150 of FIG. 14A, docking station 1150 of FIG. 14B, docking station 1150 of FIG. 15A, docking station 1150 of FIG. 15B, docking station 1150 of FIG. 16A, docking station 1150 of FIG. 16B, docking station 1150 of FIG. 16C, docking station 1150 of FIG. 17A, docking station 1150 of FIG. 17B, docking station 1150 of FIG. 18A, etc.). In some embodiments, the docking station enables the human operators and/or articulated handling robot to place one or more trays in a fixed and well-controlled position, so that the one or more trays is easily and repeatably picked up by the robotic material transfer system. In some embodiments, the docking station is configured to accommodate between 1 and 5 trays, between 1 and 3 trays, or between 2 and 3 trays. In some embodiments, the docking station is configured to accommodate at least one tray, at least 2 trays, at least 3 trays, at least 4 trays, at least 5 trays, at least 6 trays, or at least 8 trays. In some embodiments, the docking station is configured to accommodate at most one tray, at most 2 trays, at most 3 trays, at most 4 trays, at most 5 trays, at most 6 trays, or at most 8 trays. In some embodiments, the docking station also enables the robotic material transfer system to deposit outgoing trays, so that they can be retrieved by the human operators outside of a capsule assembly system. However, the present disclosure is not limited thereto. In some embodiments, the docking station includes one or more elastic springs (e.g., elastic spring 1160 of FIG. 11A, elastic spring 1160 of FIG. 11B, elastic spring 1160 of FIG. 11C, elastic spring 1160 of FIG. 12, elastic spring 1160 of FIG. 13A, elastic spring 1160 of FIG. 11B, elastic spring 1160 of FIG. 14A, elastic spring 1160 of FIG. 14B, elastic spring 1160 of FIG. 15A, elastic spring 1160 of FIG. 15B, elastic spring 1160 of FIG. 16A, elastic spring 1160 of FIG. 16B, elastic spring 1160 of FIG. 16C, elastic spring 1160 of FIG. 17A, elastic spring 1160 of FIG. 17B, elastic spring 1160 of FIG. 18A, etc.). In some embodiments, the elastic spring deform when a rigid cartridge is inserted, keeping the one or more trays in place and aligning a position of the one or more trays based on corresponding positions of an array of the elastic springs, such as automatically and passively centering the tray on a substantially planar upper surface of a base of the docking station. Since these elastic springs provide elastic and passive alignment, they are extremely robust and do not require special maintenance to function properly. Moreover, since the elastic springs are designed to operate in an elastic region of a material of the elastic springs, the elastic springs tolerate a very high number of cycles of engaging with the one or more trays. In some embodiments, a first height of a first plurality of elastic springs is different than a second height of a second plurality of elastic springs, which allows for keeping a first tray in place and aligning a first position of the first tray based on corresponding positions of the first plurality of elastic springs and for keeping a second tray different than the first tray in place and aligning a second position of the second tray based on corresponding positions of the second plurality of elastic springs. However, the present disclosure is not limited thereto. In some embodiments, a first width of a first plurality of elastic springs is different than a second width of a second plurality of elastic springs, which allows for keeping the first tray in place and aligning the first position of the first tray based on corresponding positions of the first plurality of elastic springs and for keeping the second tray having a width different than the first tray in place and aligning the second position of the second tray based on corresponding positions of the second plurality of elastic springs.

In some embodiments, the docking station and/or modular clean room system of the present disclosure is a docking station and/or modular clean room system of U.S. Pat. No. 11,198,845, entitled “System, Method, and Apparatus Facilitating Automated Modular Manufacture of Cell Therapy,” issued Dec. 14, 2021, which is hereby incorporated in its entirety for all purposes.

Accordingly, in some embodiments, each open capsule body 1900 is accommodated (e.g., aligned) within an opening (e.g., opening 1000 of FIG. 15B), such as with an open end facing in an upward orientation toward a gate mechanism (e.g., third gate mechanism 440-3 of FIG. 4). In some embodiments, the dispenser is coupled to an actuator (e.g., actuator of FIG. 6) that is configured for rotary or linear movement to change a positioning of the dispenser and accordingly a filling of the open capsule body. However, the present disclosure is not limited thereto. For instance, in some embodiments, the rotary or linear movement to change the positioning of the dispenser fills an opening of the third gate mechanism (e.g., opening of a metering plate). In some embodiments, when the actuator mechanism, such as a piston, is moved horizontally to dispense a dosage of solid dosage forms from the through holes of the dispenser into the opening of the tray through the second terminal end portion of the dispenser, a first set of one or more open capsule bodies are aligned with the second terminal end portions to receive the solid dosage forms. As the actuation mechanism is moved further (e.g., further from the hopper 402), the dispenser is moved to a position that aligns with another a second set of one or more open capsules with the second terminal end portions to facilitate further filling of capsule bodies. In some embodiments, upon determining filling of each open capsule body is satisfied, such as when a selected dosage of solid dosage forms is received by the open capsule body, each filled capsule body is further processed to be sealed to form a capsule (e.g., by combining a first capsule body with a second capsule body). However, the present disclosure is not limited thereto.

In some embodiments, an articulated handling robot handles a respective tray to move the capsules from one portion to a different portion of the capsule assembly apparatus, and to assemble the various components of the capsules, such as one or more capsule bodies, one or more dividers, or a combination thereof into the final product (e.g., a plurality of sealed capsules). As described supra, in some embodiments, the capsule assembly apparatus includes three different types of tray 900, such that each body component of a capsule structure has a corresponding tray type. In some embodiments, each type of tray is configured to only carry a corresponding capsule component that a respective tray is configured to accommodate. In some embodiment, each tray includes a plurality of through holes on a surface of the tray. In some embodiments, the plurality of through holes is arranged in a matrix having M rows and N columns. As a non-limiting example, M is about 6 and N is about 8.

In some embodiments, the body tray is configured to accommodate a plurality of capsule bodies. In some embodiments, a manufacturing (e.g., assembly) process starts when an articulated handling robot takes a body tray from an input buffer. Here, all the capsule bodies contained in the tray are empty. In some embodiments, the articulated handling robot then proceeds to deposit the intermediate formulations into the capsule bodies, weigh the capsule bodies, insert one or more dividers into the capsule bodies, and then close the capsule bodies with corresponding capsule caps to form the capsules. When the other capsule components, such as the dividers and the capsule caps, are used, the corresponding trays are brought into the process by the articulated handling robot.

In some embodiments, the divider tray is configured to accommodate one or more capsule dividers. In some embodiments, each divider is configured to partition an interior volume of the capsule or capsule body to form one or more unique interior volumes. Accordingly, each divider forms one or more unique interior volumes of the capsule based on a position of a respective divider, such as an orientation of the respective divider and/or a relative position in the interior volume, and a unique circumferential surface of the interior volume. In some embodiments, a thickness of a base of a first divider is in a range of from about 0.1 mm to about 1.5 mm (e.g., 0.2 mm, 0.8 mm, etc.). In some embodiments, a wall thickness of the sidewall of the first divider is in a range of from about 0.1 mm to about 1.5 mm (e.g., 0.2 mm, 0.8 mm, etc.). In some embodiments, the divider tray is used exclusively in the capsule assembly apparatus, and, therefore, does not leave a proximity of the capsule assembly apparatus because that is the system that inserts the dividers into the capsules. However, the present disclosure is not limited thereof.

In some embodiments, the cap tray is configured to accommodate one or more capsule bodies. Once a capsule is sealed with a capsule body (e.g., in the capsule assembly apparatus), the capsule with the capsule cap remains in the cap tray. Accordingly, in some embodiments, the cap tray is the tray that accommodates a finished capsules at the end of the assembly process. In some embodiments, the articulated handling robot then picks the cap tray from the capsule assembly apparatus and brings the cap tray to an output buffer where the cap trays that accommodate the finished capsules are stored.

Accordingly, the cap tray, the divider tray, and the base tray are designed to accommodate different capsule components, and to allow the articulated handling robot to manipulate a respective tray and assemble the capsules by way of the trays.

Referring to FIG. 10A, in some embodiments, the body tray includes a plurality of deep wells that is designed to accommodate and support a corresponding plurality of capsule bodies. In some embodiments, a capsule body is the longest components of the capsule. On a bottom end portion of each deep well in the body tray there is a hole. In some embodiments, the hole is configured to allow a pin of a capsule assembly apparatus to push the capsule body into the capsule cap in a step of the capsule assembly process.

Referring to FIG. 10B, in some embodiment, the divider tray includes a plurality of short wells that is designed to house a corresponding plurality of dividers (e.g., in a one-to-one relationship, in a one-to-many relationship). Each divider is accommodated in an upper end portion of each short well. When accommodated, each divider rest above a gate mechanism. In some embodiments, the gate mechanism includes a solid plate in a middle portion of the divider tray. In some embodiments, when the capsule assembly apparatus is inserting the dividers into the capsule bodies, the capsule assembly apparatus opens the gate and then uses a set of pins to push the dividers downwards, precisely inserting the dividers into the capsule bodies.

Referring to FIG. 10C, the cap tray includes a plurality of large wells that is configured to house a corresponding plurality of capsule caps. The large wells have large holes on both end portions—one on an upper end portion and another on a lower end portion. The large holes allow the insertion of the caps into the cap tray. On the bottom side, the large holes allow the capsule assembly apparatus to push the capsule bodies upwards, locking the capsule bodies into the capsule caps and completing a step in the assembly process.

Referring to FIGS. 11A through 18A, an exemplary capsule assembly apparatus (e.g., capsule assembly apparatus 1600 of FIG. 14A, capsule assembly apparatus 1600 of FIG. 14B, capsule assembly apparatus 1600 of FIG. 15A, capsule assembly apparatus 1600 of FIG. 15B, capsule assembly apparatus 1600 of FIG. 16A, capsule assembly apparatus 1600 of FIG. 16B, capsule assembly apparatus 1600 of FIG. 16C, capsule assembly apparatus 1600 of FIG. 17A, capsule assembly apparatus 1600 of FIG. 17B, capsule assembly apparatus 1600 of FIG. 18A etc.) is provided.

More particularly, in some embodiments, the capsule assembly apparatus includes a linear actuator (e.g., linear actuator 1610 of FIG. 16B), a hard stop (e.g., hard stop 1620 of FIG. 16C), a cap tray (e.g., second tray 900-2 of FIG. 17A), a body tray (e.g., first tray 900-1 of FIG. 17A), a plurality of capsule closing pins (e.g., pins 1630 of FIG. 16A), a linear guide (e.g., guide mechanism 650 of FIG. 16A), a plurality of divider insertion pins (e.g., pins 1640 of FIG. 16A), a divider tray (e.g., third tray of FIG. 18A), or a combination thereof. In some embodiments, the capsule assembly apparatus includes a capsule assembly workflow, a press workflow, a divider insertion workflow, or a combination thereof. In some embodiments, the capsule assembly apparatus is designed to assemble a multi-compartment capsule that includes two or more capsule bodies (e.g., a lower capsule body and an upper, or cap, capsule body) with one or more dividers accommodated by the one or more capsule bodies.

In some embodiments, the capsule assembly apparatus includes, or is in communication with, a controller that controls one or more components of the capsule assembly apparatus. In some embodiments, the capsule assembly apparatus is configured to insert one or more dividers (e.g., divider bodies) into one or more capsule bodies at specified heights. Additionally, in some embodiments, the capsule assembly apparatus is configured to couple capsule bodies and caps bodies, thereby assembling the capsule. In some embodiments, the capsule assembly apparatus utilizes a linear actuator to insert one or more dividers into one or more capsule bodies at specified heights and to couple capsule bodies together to form a sealed capsule. However, the present disclosure is not limited thereto.

In some embodiments, the articulated handling robot initiates the manufacturing workflow process at a second capsule assembly apparatus 1600 with a tray 900 accommodating empty capsule bodies. In some embodiments, a first capsule assembly apparatus (e.g., capsule assembly apparatus 300 of FIG. 3) is utilized to dispose one or more (e.g., three) different solid dosage forms into each of the capsule bodies. In some embodiments, the second capsule assembly apparatus inserts into the capsule bodies two capsule dividers, such as one after the first deposition workflow at the first capsule assembly apparatus, and the other after the second deposition procedure at the first capsule assembly apparatus. Finally, in some embodiments, the second capsule assembly apparatus couples (e.g., locks, seals) the capsule bodies with the capsule cap bodies after the third deposition procedure at the first capsule assembly apparatus. However, the present disclosure is not limited thereto.

In some embodiments, the capsule assembly apparatus includes an automated capsule assembly system and a set of auxiliary tray apparatuses, such as a set of one, two, three, or four tray apparatuses 2200. The tray apparatus stores one or more trays, such as one or more of the divider trays and the cap trays, which accommodate the extra components that the capsule assembly system will assemble onto the capsule bodies in order to realize the multi-compartment structure of a respective capsule.

In some embodiments, a capsule assembly process starts when the articulated handling robot places a capsule body tray into a lower slot of the capsule assembly system. In some embodiments, the articulated handling robot then picks a divider tray and places the divider on top of the body tray in the capsule assembly apparatus. In some embodiments, the capsule assembly apparatus automatically lowers a set of divider insertion pins 1640, which push the dividers bodies into the capsule bodies. In some embodiments, the divider insertion pins' motion is controlled by a linear actuator (e.g., linear actuator 1610 of FIG. 18C), such as with closed-loop position control. In some embodiments, this motion control is provided by the controller, which enables the capsule assembly apparatus to control and measure the height at which the divider bodies are positioned within the capsule bodies based on a position of the divider insertion pins with respect to a location of a tray. In some embodiments, after the divider bodies reach the target height, the capsule assembly apparatus retracts the divider insertion pins. In some embodiments, the articulated handling robot removes the divider tray and puts the now empty divider tray back in a tray apparatus 2200. In some embodiments, the articulated handling robot completes the workflow by picking the capsule body tray, which includes the capsule body and the dividers coupled together by the workflow and moving this tray to the next workflow in the assembly workflow, such as a cap body assembly workflow.

In some embodiments, the cap assembly process starts when the articulated handling robot places a capsule body tray into the upper slot of the capsule assembly system. The articulated handling robot then picks a cap tray, and places it on top of the body tray in the capsule assembly apparatus. At this point, the capsule assembly apparatus automatically moves up its capsule closing pins, which push the capsule bodies up into the capsule caps. The capsule closing pins' motion is controlled by a linear actuator with closed-loop position control. This enables the capsule assembly apparatus to control and measure the height at which the capsule bodies are positioned within the caps to lock the capsules. After the capsule bodies the target height, the capsule assembly apparatus retracts the capsule closing pins. The articulated handling robot then completes the process by picking the capsule caps tray and shuttling it to the next workflow in the manufacturing workflow. In some embodiments, the closed and completed capsules are located inside of the caps tray. The capsule body tray is now empty. The articulated handling robot picks it up and places it in a tray apparatus, freeing the capsule assembly apparatus for the next assembly operation.

In some embodiments, a docking station includes a first array of engagement members in a plurality of engagement members and a second array of engagement members in the plurality of engagement members. In some embodiments, each respective array of engagement members in the plurality of engagement members is configured to engage with a corresponding capsule tray in a plurality of trays. For instance, in some embodiments, each engagement member in the plurality of engagement members protrudes upwardly from a substantially planar upper surface of a base of the docking station. In some embodiments, a height of the producing from the base of the docking station is uniform (e.g., the same height) for each engagement member in the respective array of engagement members. In this way, in some such embodiments, each respective array of engagement members in the plurality of engagement members is associated with a corresponding height, which allows for each respective array of engagement members to not interfere with a different array of engagement members and further engage a unique surface (e.g., a unique surface of a different tray). In some embodiments, each engagement member in a respective array of engagement members includes a fixed body protruding upwardly from the substantially planar upper surface of the base. Moreover, each engagement member includes a spring integrally formed with the fixed body and extending inwardly from an upper end portion of the fixed body oblique to both the substantially planar upper surface of the base and the fixed body. From this, a deformable gap is formed interposing between a surface of the fixed body and a lower end surface of the spring. Accordingly, an upper end surface of the spring is configured to engage a surface of a respective capsule tray.

Referring briefly to FIG. 16, a capsule includes a capsule body, a capsule divider, and a capsule cap. In some embodiments, a method for assembling the capsule includes holding the capsule body, filling the capsule body with a first material (e.g., power), disposing a first divider in the capsule body, filling the capsule body with a second material (e.g., solid dosage forms), disposing a second divider in the capsule, filling the capsule body with a third material (e.g., liquid), disposing the capsule cap over the capsule body, or a combination thereof.

Referring to FIG. 18A through FIG. 21, a tray apparatus is provided. More particularly, a capsule assembly workflow includes a capsule assembly apparatus and a set of tray apparatus that is configured to house one or more trays. In some embodiments, this workflow includes at least three tray apparatuses, such as the capsule assembly apparatuses of FIG. 18A that includes three tray apparatuses. In some embodiments, each tray apparatus in the at least three tray apparatus is each locked through a corresponding locking mechanism 1860 in a corresponding receiving structure 1850 of a surface. In some embodiments, the corresponding receiving structure 1850 includes a locking mechanism 1860 coupling configured to engage a corresponding locking mechanism 1860 of the tray apparatus. However, the present disclosure is not limited thereto.

In some embodiments, the articulated handling robot assembles multi-compartment capsules by performing one or more workflows, in which each workflow is associated with moving one or more trays 900 from a first capsule assembly apparatus 300 to a second capsule assembly apparatus 1600, from the first capsule assembly apparatus 300 to a tray apparatus 2200, from the second capsule assembly apparatus 300 to the tray apparatus 2200, from the second capsule assembly apparatus 1600 to the first capsule assembly apparatus 300, from the tray apparatus 2200 to the first capsule assembly apparatus 300, from the tray apparatus 2200 to the second capsule assembly apparatus 1600, or a combination thereof. In some embodiments, each workflow performs a specific task of the entire manufacturing workflow; such as a first workflow from depositing solid dosage forms via the first capsule assembly apparatus into a tray, a second workflow for weighing the tray, a third workflow for assembling the capsules at the second capsule assembly apparatus 1600, or a combination thereof, which collectively form a fourth manufacturing workflow. However, the present disclosure is not limited thereto. In some embodiments, in order to operate, the articulated handling robot needs access to a reservoir of trays accommodating empty capsule bodies, capsule dividers, capsule caps, or a combination thereof. In some embodiments, the articulated handling robot also needs a buffer function, such as space to store the trays that accommodate the capsules that have been completed after going through all the steps in the manufacturing workflow. In some embodiments, this buffer function is realized using the tray apparatus of the present disclosure.

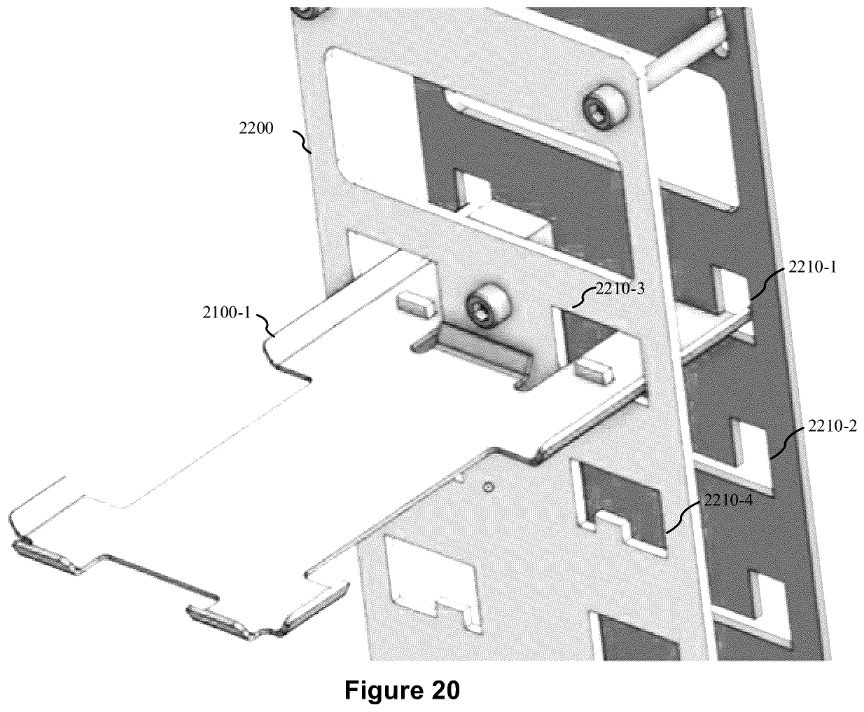

In some embodiments, a tray apparatus (e.g., tray apparatus 2200-1 of FIG. 18A, tray apparatus 2200-2 of FIG. 18A, tray apparatus 2200-3 of FIG. 18A, tray apparatus 2200 of FIG. 18B, tray apparatus 2200 of FIG. 19A, tray apparatus 2200 of FIG. 20, etc.) that is configured to stores one or more capsule trays 900 in a well-defined location, such as a predetermined location defined by a docking station. In some embodiments, the tray apparatus is configured to store between 2 and 50 trays, between 3 and 20 trays, between 5 and 15 trays, or between 7 and 14 trays. In some embodiments, tray apparatus is configured to store at least 2 trays, at least 3 trays, at least 6 trays, at least 10 trays, at least 15 trays, at least 20 trays, at least 25 trays, or at least 50 trays. In some embodiments, tray apparatus is configured to store at most 2 trays, at most 3 trays, at most 6 trays, at most 10 trays, at most 15 trays, at most 20 trays, at most 25 trays, or at most 50 trays.

This allows the articulated handling robot to pick one or more trays 900 up when needed in the manufacturing workflow. Additionally, in some embodiments, an empty tray apparatus is used to store one or more trays accommodating finished capsules, or one or more empty trays whose capsule components have already been used in the manufacturing workflow: In some embodiments, each capsule tray is stored on a shelf. In some embodiments, each shelf is a three-dimensional monolithic structure, such as a singular piece of bent sheet metal. In some embodiments, the shelf is fabricated from stainless steel, and one or more edge portions (e.g., corners) is rounded upwardly, such as to increase cleanability. In some embodiments, the one or more edge portions of the shelf include a chamfer that uses gravity to favor the correct alignment of the tray after the tray is placed on the shelf. However, the present disclosure is not limited thereto.

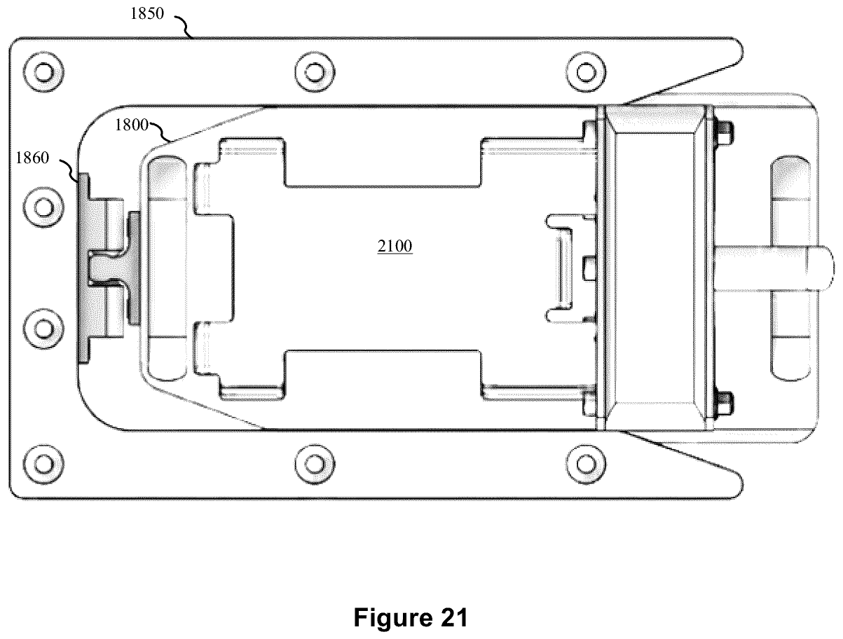

In some embodiments, the tray apparatus is loaded or unloaded with one or more trays by a human manufacturing operator. In some embodiments, the tray apparatus includes a base 1800 that is configured to allow the tray apparatus to rest on a surface, such as a table. In some embodiments, the base includes a locking mechanism (e.g., locking mechanism 1860 of FIG. 21) that is configured to securely lock into the base of the tray apparatuses with a receiving structure 1850 of the surface. In some embodiments, each tray apparatus is equipped with one or more handles, such as a first handle disposed on an upper end portion of the tray apparatus and/or a second handle disposed on a front-end portion of the base. However, the present disclosure is not limited thereto. In some embodiments, the handle is configured to allow the tray apparatus to move, such as during loading and/or unloading of the trays from the one or more shelves of the tray apparatuses.

In some embodiments, the material of the tray apparatus includes stainless steel (e.g., one or more shelves includes stainless steel and/or one or more back structures, such as back plates, that hold the one or more shelves includes stainless steel). In some embodiments, the tray apparatus includes an acetal copolymer, such as the one or more base plates and one or more spacers of the tray apparatuses. In some embodiments, the tray apparatus is configured for rapid assembly and/or disassembly, and for easy cleanability. Finally, in some embodiments, a modular structure of the tray apparatuses and/or of one or more shelves (e.g., one or more input shelf buffers and/or one or more output shelf buffers) ensures a possibility of quick changeovers and swaps between components, devices, apparatuses, and systems of the modular capsule assembly system. In some embodiments, the one or more shelf buffers is necessary during the normal operation of the articulated handling robot. As a non-limiting example, to load a second tray apparatus to refill the system and/or during maintenance procedures, such as for example, to replace a damaged shelf. However, the present disclosure is not limited thereto.

Accordingly, in some embodiments, the tray apparatus is modular. For instance, in some embodiments, one or more shelves of the tray apparatus is added or replaced by the articulated handling robot in accordance with a determination of a number of tray apparatuses needed by the modular capsule assembly system. In some embodiments, each shelf is accommodated by the tray apparatus via a slow (e.g., tray slots 2210 of FIG. 18B, tray slots 2210 of FIG. 19A, tray slots 2210 of FIG. 20, etc.). In some embodiments, each slot includes a protrusion, such as a tab, that protrudes towards a center of an opening formed by the slot. In some embodiments, the protrusion is formed at a bottom end portion of the slot and extends upwardly towards the center of the opening formed by the slot. Accordingly, in some such embodiments, due to one or more protrusions, the tray apparatus does not require any fastening mechanism, such individual bolts or similar fastener mechanism, to removably couple a tray to the tray apparatus. In some embodiments, a human operator or an articulated handling robot just needs to remove the tray apparatus from a respective locking mechanism 1860, fill the tray apparatus with one or more trays by disposing the one or more trays on one or more corresponding shelves that are further disposed on the tray apparatus, and further disposing the tray apparatus back into the locking mechanism. However, the present disclosure is not limited thereto. In some embodiments, the articulated handling system conducts all steps and processes since the docking station and the tray apparatus completely define a position of the one or more trays in the modular capsule assembly system. In this way, in some embodiments, the articulated handling system picks the one or more trays up by way of the tray apparatus. Accordingly, in some embodiments, the tray apparatus is scalable to accommodate any number of trays in the one or more trays. For instance, in some embodiments, the docking station is configured to accommodate two or more trays, in which each tray in the two or more trays is a different type of tray, such as a divider tray, a body tray, or the like. Accordingly, in some embodiments, the docking station allows the sensor (e.g., two-dimensional pixelated detector, visual inspection module, etc.) to utilize a single sensor and a single docking station for multiple types of inspection workflows.

In some embodiments, the structure of the one or more shelves allows the one or more shelves to be made from stainless-steel, such as stainless-steel sheet metal. The sheet metal is laser cut and bent, and the shelf is ready for use. In some embodiments, the tray apparatus is cleanable, such that the tray apparatus is designed to be easily assembled and disassembled. In some embodiments, by removing a fastener mechanism of the tray apparatus, such as by unbolting one or more front plates and/or one or more back plates, each shelf and/or slot is unobstructed, which allows for individual cleaning. Furthermore, in some embodiments, the tray apparatus lacks sharp edges, such as by included one or more chamfer and/or rounded edges. Moreover, in some embodiments, the one or more slots is made of stainless steel, so the one or more slots is safe for pharmaceutical processes, such as assembling the plurality of capsules.

Referring briefly to FIG. 19B, in some embodiments, a capsule ca body tray is provided. In some embodiments, that can be seated in multiple docking station types. In some embodiments, the tray is accommodated in a first docketing station configured for visual inspection, a second docking station configured for capsule assembly, a third docking station configured to retain one or more pallets of capsules, or a combination thereof. In some embodiments, each docking station includes unique exterior features, such as one or more grooves or ridges, that require unique alignment for an articulated handling robot to facilitating handling the tray. However, the present disclosure is not limited thereto.

In some embodiments, the tray apparatus 2200 includes one or more shelves (e.g., shelf 2100 of FIG. 20). In some embodiments, an upper surface of the shelf 2100 is configured to receiving a tray 900 in the one or more trays of the present disclosure.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

### REFERENCES CITED AND ALTERNATIVE EMBODIMENTS

All references cited herein are incorporated herein by reference in their entirety and for all purposes to the same extent as if each individual publication or patent or patent application was specifically and individually indicated to be incorporated by reference in its entirety for all purposes.

The present invention can be implemented as a computer program product that includes a computer program mechanism embedded in a non-transitory computer-readable storage medium. For instance, the computer program product could contain instructions for operating the user interfaces described with respect to FIG. 2. These program modules can be stored on a CD-ROM, DVD, magnetic disk storage product, USB key, or any other non-transitory computer readable data or program storage product.

Many modifications and variations of this invention can be made without departing from its spirit and scope, as will be apparent to those skilled in the art. The specific embodiments described herein are offered by way of example only. The embodiments were chosen and described in order to best explain the principles of the invention and its practical applications, to thereby enable others skilled in the art to best utilize the invention and various embodiments with various modifications as are suited to the particular use contemplated. The invention is to be limited only by the terms of the appended claims, along with the full scope of equivalents to which such claims are entitled.

What is claimed is:

1. A capsule assembly apparatus comprising:
a hopper configured to retain a first plurality of a solid dosage form, wherein the hopper comprises:
an inlet for receiving a member in the first plurality of solid dosage forms, and
an outlet for conveying the member in the first plurality of solid dosage forms towards a dispenser;
the dispenser comprising a plurality of through holes configured to receive at least two members in the first plurality of solid dosage forms, wherein each through hole in the plurality of through holes comprises:
a first terminal end portion configured to receive the member in the first plurality of solid dosage forms at a first end portion of the dispenser, and
a second terminal end portion configured to discharge the member in the first plurality of solid dosage forms at a second end portion opposite the first end portion of the dispenser;
a first gate mechanism disposed interposing between the outlet of the hopper and the dispenser, wherein the first gate mechanism is configured to control the conveying of the member in the first plurality of solid dosage forms;
a first actuation mechanism configured to control a movement of the hopper in a first direction; and
a tray comprising a plurality of openings, wherein each opening in the plurality of openings is configured (i) to accommodate both a body and the member in the first plurality of solid dosage forms and (ii) substantially align directly below the second terminal end portion of a respective through hole in the plurality of through holes.

2. The capsule assembly apparatus of claim 1, wherein the capsule assembly apparatus further comprises a transport mechanism disposed at a lower end portion of the hopper, the transport mechanism configured to covey the member in the first plurality of solid dosage forms from a portion of the hopper towards at least the outlet of hopper.

3. The capsule assembly apparatus of claim 1, wherein the outlet is disposed at a position at or above of the maximum height of the respective through hole in the plurality of through holes of the dispenser.

4. The capsule assembly apparatus of claim 1, wherein the capsule assembly apparatus further comprises a second gate mechanism disposed adjacent to the outlet of the hopper, wherein the second gate mechanism is configured to control access by the member in the first plurality of solid dosage forms through the outlet of the hopper.

5. The capsule assembly apparatus of claim 1, wherein the first gate mechanism comprises one or more channels configured to control the conveying the member in the first plurality of solid dosage forms through the capsule assembly apparatus.

6. The capsule assembly apparatus of claim 5, wherein the first gate mechanism comprises:
a first cam mechanism configured to control the conveyance of the member in the first plurality of solid dosage forms received by the channel in the one or more channels of the first gate mechanism, and
a second cam mechanism configured to control the conveying of the member in the first plurality of solid dosage forms discharged by the channel in the one or more channels of the first gate mechanism.

7. The capsule assembly apparatus of claim 6, wherein the first cam mechanism and the second cam mechanism collectively utilize a second actuation mechanism.

8. The capsule assembly apparatus of claim 1, wherein the capsule assembly apparatus further comprises a third gate mechanism disposed interposing between the dispenser and the tray, wherein the third gate mechanism is configured to control the discharge of the member in the first plurality of solid dosage forms from the dispenser.

9. The capsule assembly apparatus of claim 8, wherein the third gate mechanism comprises a metering plate.

10. The capsule assembly apparatus of claim 1, wherein the dispenser is a three-dimensional monolithic body.

11. The capsule assembly apparatus of claim 1, wherein the dispenser further comprises a surface extending from an upper end portion of the dispenser towards the outlet of the hopper.

12. The capsule assembly apparatus of claim 11, wherein the surface comprises a plurality of grooves, each groove in the plurality of grooves comprising a third terminal end portion adjacent to a corresponding first terminal end portion of a respective through hole.

13. The capsule assembly apparatus of claim 1, wherein each opening in the plurality of openings of the tray is individually spaced at a predetermined interval along a dimension of the tray.

14. The capsule assembly apparatus of claim 1, further comprising a third actuation mechanism configured to control a movement of the tray or the dispenser in a linear direction.

15. The capsule assembly apparatus of claim 1, wherein the hopper, the dispenser, the tray, or a combination thereof comprises a transparent or translucent material.

16. The capsule assembly apparatus of claim 1, wherein each solid dosage form in the first plurality of solid dosage forms comprises a first size between 2 millimeter (mm) and 35 mm.

17. The capsule assembly apparatus of claim 1, wherein each solid dosage form in the first plurality of solid dosage forms comprises a rotationally symmetrical body comprising a side wall and a base.

18. The capsule assembly apparatus of claim 1, wherein a surface of the tray comprises a two- or three-dimensional indicium.

19. The capsule assembly apparatus of claim 1, wherein each opening in the plurality of openings comprises a second size at a first end portion of the tray and a third size at a second end portion of the tray, wherein a first size of each solid dosage form in the first plurality of solid dosage forms is (i) equal to or less than the second size of each opening and (ii) greater than the third size of each opening.
